(19) United States
(12) Patent Application Publication
(10) Pub. No.: US 2019/0050950 A1
(43) Pub. Date: Feb. 14, 2019

(54) SYSTEM AND METHOD FOR A CUSTOMER ENGAGEMENT PLATFORM TO INCREASE RESIDENTIAL WATER USE EFFICIENCY

(71) Applicant: WaterSmart Software, Inc., San Francisco, CA (US)

(72) Inventors: Douglas Flanzer, Burlingame, CA (US); Peter Lawrence Yolles, Burlingame, CA (US)

(21) Appl. No.: 16/128,000

(22) Filed: Sep. 11, 2018

Related U.S. Application Data
(62) Division of application No. 14/063,684, filed on Oct. 25, 2013, now abandoned.
(60) Provisional application No. 61/719,302, filed on Oct. 26, 2012.

(51) Int. Cl. G06Q 50/06; G06Q 10/06

(52) U.S. Cl. CPC G06Q 50/06; Y02A 20/218; G06Q 10/06311

(57) ABSTRACT

A computer-implemented method is disclosed for providing a customer engagement platform to increase residential water user efficiency, wherein the method is implemented in one or more servers programmed to execute the method, the method comprising: estimating, with the one or more servers, one or more end uses of water for a household, wherein the estimating includes calculating water consumption for each end use.

### CROSS REFERENCE TO RELATED APPLICATIONS

This application is a divisional application of U.S. application Ser. No. 14/063,684, filed on Oct. 25, 2013 which claims priority to U.S. Provisional Application Ser. No. 61/719,302, filed Oct. 26, 2012, which are both incorporated by reference herein.

### FIELD OF THE INVENTION

The present invention relates to a system and method for a customer engagement platform to increase residential water use efficiency.

### BACKGROUND OF THE INVENTION

Efficient water-use can have major environmental, health-related, energy efficiency and economic benefits to governmental agencies, utility administrators, water customers and the public at-large. Efficient water-use can, for example, help to improve water quality, maintain aquatic ecosystems, protect drinking water resources, reduce energy consumption (embedded energy and direct energy from heating water) and mitigate the effects/risks of drought. Efficiency measures can also save a homeowner and/or resident money on their water and energy bills.

Water efficiency is also an important priority for entities that own, operate and/or maintain the water distribution network, such as local city governments, special purpose districts or agencies, and/or private/commercial enterprises (hereinafter referred to as “Utility” or “utility”). A water utility often wants to be able to educate and communicate with residents regarding their water use and water efficiency, to improve its understanding of residential water-use, and to reduce annual water demand. The automated collection of information and the coordination of this data can prove to be difficult and cumbersome because of the collaboration needed.

The need exists for a system and method that overcomes the above problem as well as provide additional benefits.

### SUMMARY OF THE INVENTION

A system and method are provided for a customer engagement platform to increase residential water use efficiency.

In accordance with an embodiment of in the present invention, a computer-implemented method is disclosed for providing a customer engagement platform to increase residential water user efficiency, wherein the method is implemented in one or more servers programmed to execute the method, the method comprising: estimating, with the one or more servers, outdoor irrigable area of a household, wherein the estimating includes calculating outdoor irrigable land of the household for estimating outdoor water usage of the household.

In accordance with another embodiment of the present invention, a computer-implemented method is disclosed for providing a customer engagement platform to increase residential water user efficiency, wherein the method is implemented in one or more servers programmed to execute the method, the method comprising: estimating, with the one or more servers, one or more end uses of water for a household, wherein the estimating includes calculating water consumption for each end use.

In accordance with yet another embodiment of the present invention, a customer-engagement system is disclosed for increasing water user efficiency comprising: a data storage area to store: a consumer database, wherein information pertaining to a registered consumer is stored in the consumer database; a property information database, wherein information pertaining to a property of the registered consumer is stored in the property information database; and a water account database, wherein information pertaining to water usage of a household of the registered consumer is stored in the water account database; and one or more servers coupled to the data storage area, wherein the one or more servers are programmed to execute computer program modules. The computer program modules comprise: a module for estimating water consumption by one or more end uses of a household and identifying saving measures with suggested changes for the end uses; and a module for generating a targeted report to the customer about the estimated water consumption and saving measures.

In accordance with yet another embodiment of the present invention, a computer-implemented method is disclosed for providing a customer engagement platform to increase residential water-user efficiency, wherein the method is implemented in one or more servers programmed to execute the method, the method comprising: defining a taxonomy, with the one or more servers, of a plurality of parameters associated with a household; creating a cohort bucket, with the one or more servers, of a select number of the plurality of parameters for comparing water usage with households having the same parameters; assigning the household to the cohort bucket; and calculating percentile score for water usage of the household for comparing percentile scores of a plurality of households assigned to the same cohort bucket.

In accordance with yet another embodiment of the present invention, a computer-implemented method is disclosed for providing a customer engagement platform to increase residential water-user efficiency, wherein the method is implemented in one or more servers programmed to execute the method, the method comprising: defining one or more content modules, with the one or more servers, relating to water consumption of a household; launching a report engine, with the one or more servers, to process the one or more content modules for a report based on the water consumption of the household; for each household, interesting attributes, with the one or more servers, with eligibility requirements for each content module; select a number of content modules, with the one or more servers, required to prepare report based on the water consumption of the household; and prepare a report, with the one or more servers, for the household.

In accordance with yet another embodiment of the present invention, a computer-implemented method for providing a customer engagement platform to increase residential water use efficiency, wherein the method is implemented in one or more servers programmed to execute the method, the method comprising: measuring water usage data periodically, with the one or more servers, of a household; analyzing the water usage data, with the one or more servers, to determine a water leak at a household; recording a leak data, with the one or more servers, if a water leak is determined; and displaying leak data to occupant.

In accordance with yet another embodiment of the present invention, a customer-engagement system for water use efficiency comprising: a data storage area to store: a consumer database, wherein information pertaining to a registered consumer is stored in the consumer database; a property information database, wherein information pertaining to a property of the registered consumer is stored in the property information database; and a water account database, wherein information pertaining to water usage of a household of the registered consumer is stored in the water account database; and a server coupled to the data storage area, wherein the server comprises: a recommendation module coupled to the data storage area, the recommendation module configured to: estimate how and where water is being used by the household; perform a benchmark comparison of the household's water usage to a plurality of comparable households; and display a water report related to the household's water usage.

In accordance with yet another embodiment of the present invention, a computer-implemented method is disclosed for increasing customer engagement and education concerning the customer's water usage efficiency wherein the method is implemented in one or more servers programmed to execute one or more computer program modules, the modules comprising: a module for estimating water consumption by one or more end uses of a customer household and identifying saving measures with suggestions to the customer for changes for the end uses; and a module for generating a targeted report to the customer about estimated water consumption, saving measures, and/or comparisons of the household's water usage to a one or more comparable households.

In accordance with yet another embodiment of the present invention, a computer-implemented method is disclosed for providing a customer engagement platform to increase residential water use efficiency, wherein the method is implemented in one or more servers programmed to execute the method, the method comprising: estimating water consumption of a customer household; identifying changes that may affect the water consumption of the customer's household; and offering incentives to the customer to make the changes that may affect the customer's water consumption.

### BRIEF DESCRIPTION OF THE DRAWINGS

Examples of a system and method for deploying a customer engagement platform to increase residential water-use efficiency are illustrated in the figures.

FIG. 1 is a block diagram illustrating an environment in which a customer engagement platform for water-use efficiency operates in accordance with an embodiment of the present invention.

FIG. 2 is a block diagram of the customer engagement platform for water-use efficiency in accordance with an embodiment with the present invention.

FIG. 3 depicts an example of the high-level flow of communications in which aspects of the invention may operate.

FIG. 4 depicts a high-level block diagram of the flow of data for through the central server of FIG. 1 for generating water usage information.

FIG. 5 depicts several modules (software) of the central server 120 in FIGS. 1 and 2 in accordance with another embodiment.

FIG. 6 depicts the high-level method steps of the outdoor irrigable land estimation module of the central server of FIG. 5.

FIG. 7 depicts an example of property for which an irrigable land area is calculated.

FIG. 8 depicts the high-level steps of end use estimation and comparison module in the central server in FIG. 5.

FIG. 9 depicts the high-level steps of attribute grouping comparison Module in the central server shown in FIG. 5.

FIG. 10 depicts the high-level steps of the report adaptation and targeting module in the central server shown in FIG. 5.

FIG. 11 depicts the high-level process steps of the leak detection module in the central server shown in FIG. 5.

FIG. 12 depicts detailed process steps of the leak detection module in the central server shown in FIG. 5.

FIG. 13 is an example of such a pie chart depicting water end usage.

FIGS. 14, 15 and 16A-16B provide examples of two printed water reports and an emailed home water report as provided by a customer engagement platform for water-use efficiency.

FIGS. 17-20 represent examples of several interfaces generated by the water efficiency customer portal (for households).

FIG. 19-20 also illustrates examples of user interfaces generated by the water efficiency customer portal for water-use efficiency in some embodiments.

FIGS. 21 and 22 depict examples of a water efficiency dashboard.

FIG. 23 depicts a block diagram of a general-purpose computer to support the embodiments of the computer-implemented systems and methods disclosed herein.

### DETAILED DESCRIPTION OF THE INVENTION

Various embodiments of the invention will now be described. The following description provides specific details for a thorough understanding and an enabling description of these embodiments. The terminology used in the description presented below is intended to be interpreted in its broadest reasonable manner, even though it is being used in conjunction with a detailed description of certain specific embodiments of the invention.

Embodiments for deploying a customer engagement platform to increase residential water-use efficiency are described. The system analyzes a variety of data, measurements and voluntary responses related to a consumer's use of water to evaluate the efficiency of customer-water use. The system presents this information to consumers to make it easier for them to conserve water and makes recommendations as to how to economize and/or reduce their usage of water. The system also provides analytics to public utility agents to assist in resource management and conservation.

In one embodiment of a customer engagement platform, the system offers services in support of an outreach program (hereinafter “program”) intended to facilitate the communication with consumers regarding their water-usage, to improve a public utility's understanding of water use by consumers such as, but not limited to, residential or commercial customers, and reduce annual water demand. The system also collects consumer data (e.g., number of occupants at a residential account, irrigable area of lot) and makes such data available to the public utility to help plan additional water efficiency strategies. In turn, the system allows for a transparency among parties that can yield significant savings relative to current utilization levels and give rise to changes in consumer behavior such as installation of additional water-saving fixtures, appliances, landscaping, and irrigation options.

In some embodiments, the system provides on a routine-basis a water-use report that can be distributed via e-mail, mail, or other mode of communication. For example, the system emails a water-use report every billing period over a twelve-month period to select consumers. The report presents customer-specific water-user data and comparisons, customized water-saving recommendations, and possible opportunities for streamlined rebates and reward points.

In one embodiment, the system performs an analysis on program participants in comparison to non-participants. For example, at the end of one year, the system does an analysis of participants versus non-participants, which can be presented to a public utility. Acknowledging that there may be differences among those who choose to opt-in to the program compared those who do not, the system reviews the engagement rates, participation rates and consumption changes among those residents who participate in the water-efficiency program and those who do not. For example, the system matches participant and non-participant water-use over, at a minimum, the last 24 months preceding the start of the program, in order to approach equivalence between the participant and non-participant groups at the start of the program. Demographic factors are also incorporated into the analysis.

Other embodiments of the system and method are described herein.

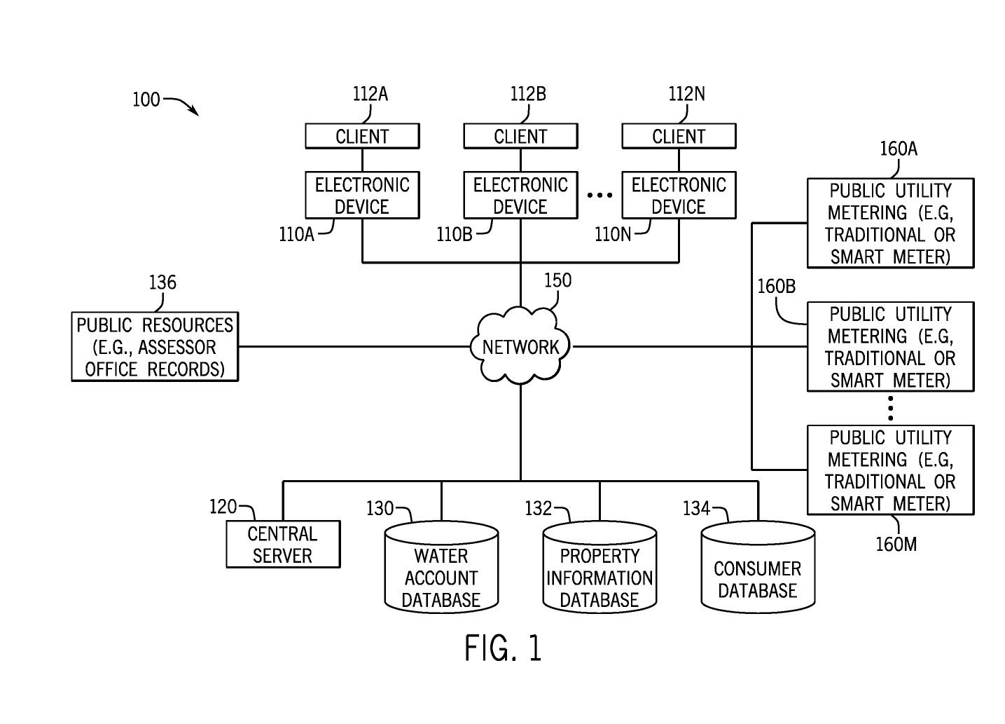

FIG. 1 is a block diagram illustrating an environment in which a customer engagement platform for water-use efficiency operates in some embodiments. In FIG. 1, a plurality of electronic devices 110A-N, a plurality of clients 112A-N, a plurality of public utility metering 160A-M, are coupled via a network 150 to a central server 120, a water account database 130, a property information database 132, and a consumer database 134, according to one embodiment. (Figure is also referred to “Fig.” herein.)

The plurality of electronic devices 110A-N can be any system and/or device, and/or any combination of devices/systems that has an electronic display for presenting information to a user and may establish a connection via the network 150 to the central server 120. Examples of electronic devices 110A-N include, but are not limited to, personal computers, laptop computers, tablets (e.g., iPad), computer clusters, television sets, mobile telephones such as smartphones (e.g., iPhone, Android phones), in-home displays, and personal digital assistants. The electronic devices 110A-N may be coupled to the network 150 by an electrical cable, an optical cable, wirelessly, or by any other method. Users of the electronic devices 110A-N may have the ability to view and utilize the web-based customer engagement platform for water-efficiency software.

The plurality of clients 112A-N may be an individual person, a business, a governmental agency, or any other entity. For example, a client may be a water-consumer serviced by a water utility (e.g., occupant(s) of a household or other user) or a staff member or an administrator of a public utility, or the like.

The network 150 is any public or private network suitable for communicably coupling clients 110A-N and agents to the telecommunications system 130. The network 150 may be any collection of distinct networks operating wholly or partially in conjunction to provide connectivity to clients 110A-N and may appear as one or more networks to the serviced parties, systems, and/or devices.

Public utility metering 160A-M each includes, among other components, meters (traditional or smart meters) and other components on or proximate properties (household/residential and commercial) as known to those skilled in the art. The terms residential property, household and home are all used to mean a place where one lives, and these terms are used interchangeably throughout this specification. An occupant of a household (residential property or home) is person who lives at such household.

The network 150 may include, but is not limited to, an Internet/web-based network, Voice over Internet Protocol (VoIP) network, a cellular telecommunications network, a public-switched telephone network (PSTN), any combination of these networks, or any other suitable network that can carry telecommunications. In one embodiment, communications over the network 150 may be achieved by a secure communications protocol, such as secure sockets layer (SSL), or transport layer security (TLS). In addition, communications can be achieved via one or more wireless networks, such as, but is not limited to, one or more of a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G networks, enhanced data rates for GSM evolution (EDGE), General packet radio service (GPRS), enhanced GPRS, messaging protocols such as, TCP/IP, SMS, MMS, extensible messaging and presence protocol (XMPP), real time messaging protocol (RTMP), instant messaging and presence protocol (IMPP), instant messaging, USSD, IRC, Zigbee or any other wireless data networks or messaging protocols.

The water account database 130, property information database 132, and consumer database 134 may store information such as software, descriptive data, images, video, photos, system information, and/or any other data item utilized by the modules of the central server 120 for operation. The databases 130, 132, 134 can be implemented via object-oriented technology and/or via text files, and can be managed by a distributed database management system, an object-oriented database management system (OODBMS) (e.g., ConceptBase, FastDB Main Memory Database Management System, JDOlnstruments, ObjectDB, etc.), an object-relational database management system (ORDBMS) (e.g., Informix, OpenLink Virtuoso, VMDS, etc.), RDBMS (MySQL) a file system, and/or any other convenient or known database management package.

Consumer database 134, property information database 132 and/or other database may include household account data such as customer name, address and personal data, lot size, occupant number residing at locations, appliance types, models, year and quantity and irrigation system to name a few.

The central server 120 is, in some embodiments, able to communicate with electronic devices 110A-N and/or public utility metering 160A-M via the network 150. In one embodiment, the central server 120 indirectly receives water usage information from a public utility that meters (e.g., traditional or smart meters) and tracks water-use of residential, municipal and commercial properties. In some embodiments, the central server 120 directly receives water usage information directly from a public utility metering. In some cases, water usage information is received from a third party vendor contracted by a utility to maintain or collect meter data and distribute-as-requested by the utility.

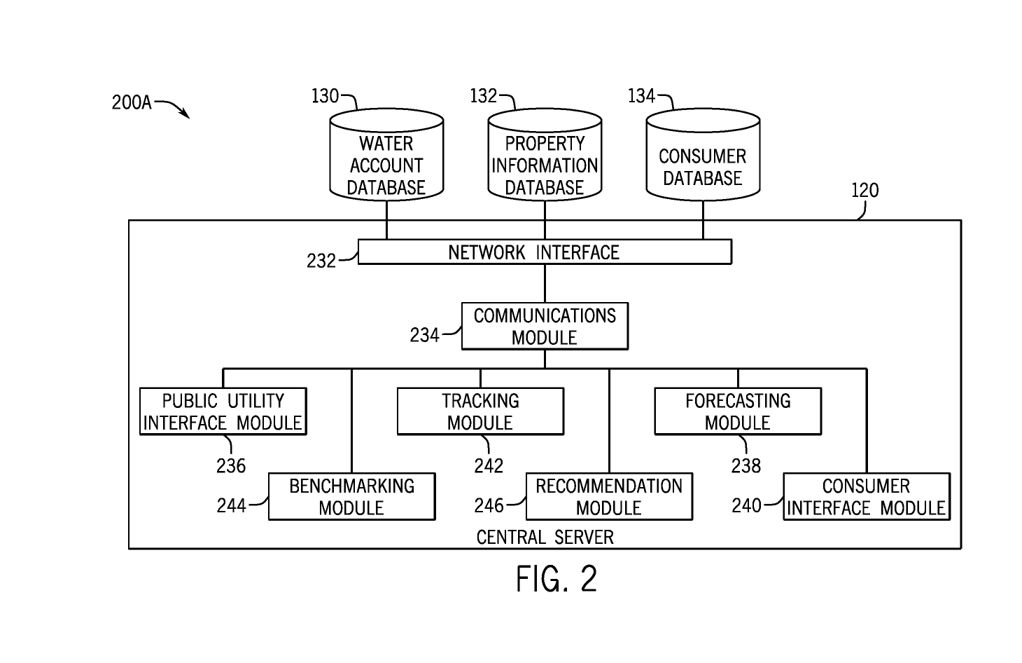

FIG. 2 depicts an example block diagram 200A illustrating the customer engagement platform for water-use efficiency. The customer engagement system includes a central server 120 coupled to a water account database 130, a property information database 132, and a consumer database 134.

In the example of FIG. 2, the central server 120 includes a network interface 232, firewall (not shown), communications module 234, public utility interface module 236, tracking module 242, benchmarking module 244, a recommendation module 246, and a forecasting module 238. Additional or fewer modules may be included as known those skilled in the art. FIG. 5 depicts another block diagram of the server central 120 wherein several modules are shown in addition to the modules shown in FIG. 1. The central server 120 may be communicatively coupled to a water account database 130, a property information database 132, and/or a consumer database 134 as illustrated in FIG. 2. In some embodiments, the water account database 130, a property information database 132, and/or a consumer database 134 are partially or wholly internal to the central server 120.

In the example of FIG. 2, the network interface 232 can be one or more networking devices that enable the central server 120 to mediate data in a network with an entity that is external to the central server, through any known and/or convenient communications protocol supported by the central server and the external entity. The network interface 232 can include one or more of a network adaptor card, wireless network interface card, router, access point, wireless router, switch, multilayer switch, protocol converter, gateway, bridge, bridge router, hub, digital media receiver, and/or repeater.

A firewall, can, in some embodiments, be included to govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand. In some embodiments, the functionalities of the network interface 232 and the firewall are partially or wholly combined and the functions of which can be implemented in any combination of software and/or hardware, in part or in whole.

In the example of FIG. 2, the central server 120 includes the communications module 234 or a combination of communications modules communicatively coupled to the network interface 232 to manage a one-way, two-way, and/or multi-way communication sessions over a plurality of communications protocols. In one embodiment, the communications module 234 receives data (e.g., video data, textual data, video files, etc.), information, commands, requests (e.g., text-based), and/or text-based messages over a network.

Since the communications module 234 is typically compatible with receiving and/or interpreting data originating from various communication protocols, the communications module 234 is able to establish parallel and/or serial communication sessions with users of remote client devices for data and command exchange (e.g., user information and/or advertising content). In addition, the communications module 234 can manage log-on requests received from one or more clients (e.g., consumers or public utility agents) connecting to the central server 120 to receive account information or other water-use related information.

For example, the platform may utilize a username/email and password identification method for authorizing access. The communications module 234 can gather data to determine if the user is authorized to access the system and if so, securely logs the user into the system. In other embodiments, other forms of identity authentication, include but is not limited to, security cards and digital certificates can be utilized and are contemplated and in accordance with this disclosure. A user may be able to specify and/or obtain a Login ID after subscribing or registering. In addition, other forms of identification including as social logins such as Facebook Connect, and Single Sign-On (SSO) with existing utility authentication schemes.

One embodiment of the central server 120 includes a recommendation module 246. The recommendation module 246 may be any combination of software agents and/or hardware components able to process information gathered by other modules such as the tracking module 242, public utility interface module 236, consumer interface modules 240, and the databases 130, 132, 134.

In one embodiment, the recommendation modules factor-in water-use and account information about a household, publicly-available property information, and household information provided explicitly by a consumer via e.g., a household profile into an algorithm to accurately calculate a variety of assessments. These assessments include, but are not limited to, an estimate of how and where water is being used by a household (including both indoor and outdoor use), a determination of reasonable comparative benchmarks for the household's water-use, an interpretation of water usage and appropriate recommendations for reducing consumption, and a forecast of potential water and cash savings that water-saving actions would deliver as a result of reduced water charges, reduced sewer charges (where appropriate), and reduced energy charges (where appropriate).

One embodiment of the recommendation module employs both theoretical and empirical models to drive its algorithms. The theoretical model algorithm uses explicit answers provided by a consumer about his/her household's appliances, irrigation devices, behaviors, and circumstances (e.g., via the household profile) to determine the aforementioned estimates and forecasts. The empirical model algorithm looks at historical usage data and draws conclusions using known variables like seasonality and irrigable yard area to determine the aforementioned estimates and forecasts. The consumer web portal uses the recommendation module to guide consumers in their understanding of water use, to recommend actions to reduce their use, which ultimately allows residents to see the outcomes of their water-saving behaviors.

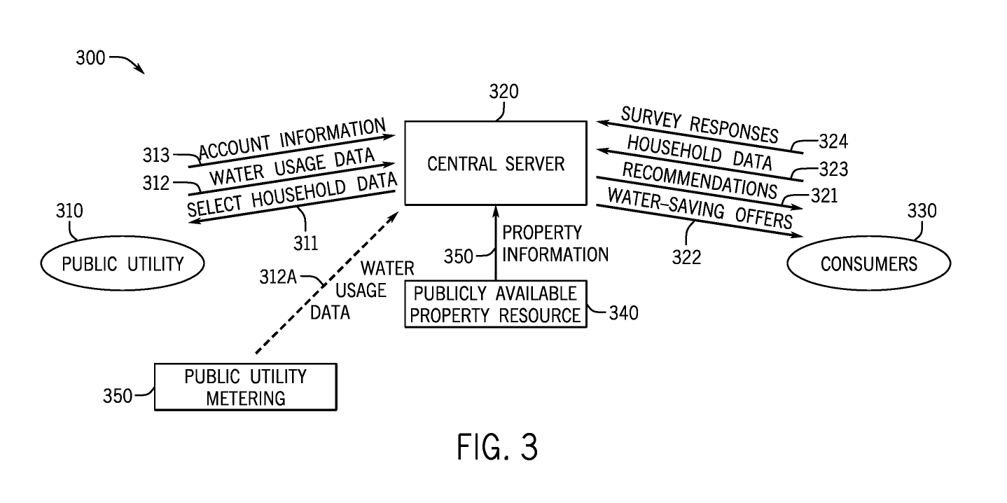

FIG. 3 depicts an example 300 of the flow of communications, including but not limited to, select household data 311, water-usage data 312, account information 313, recommendations 321, water-saving offers 322, household data 323, survey responses 324, and property information 350 among a public utility 310, consumers 330, public available property resource, and public utility metering 350. The public utility 310 may be any company, organization, entity, or individual desiring to implement water-efficiency measures and/or services and can provide valuable account and/or water-use data, and utilize select household data to implement water-efficiency measures. The consumers 330 are users of water service and have electronic devices on which information, reports, or messages provided by the system may be displayed; or are users of water service and receive communications from the system via non-electronic (e.g., post-office) mail or telephone call. Consumers may be residential (household), commercial, institutional, municipal, irrigation or industrial customers of the public utility. The consumers are not necessarily the owners of the electronic devices that they use. For example, consumers may be employees of a company that owns the computers used by consumers. The central server 320 is an intermediary between the public utility 310 and consumers 330 and serves to provide a consumer—engagement platform for efficient water—us such as software to the consumers.

The information received by central server 320 may be from multiple sources and are not necessarily from the entities shown in FIG. 3. For example, water-usage data 312 may not necessarily be received from a public utility 310, but be remotely and/or wirelessly received from a public utility metering tool 350 on the site of the residential or commercial consumer. As another example, property information 350 that is typically public information may not be received from resource 340, but may be transferred from the public utility 310. Those skilled in the art will recognize that other resources not otherwise detailed herein may be received by the central server 320.

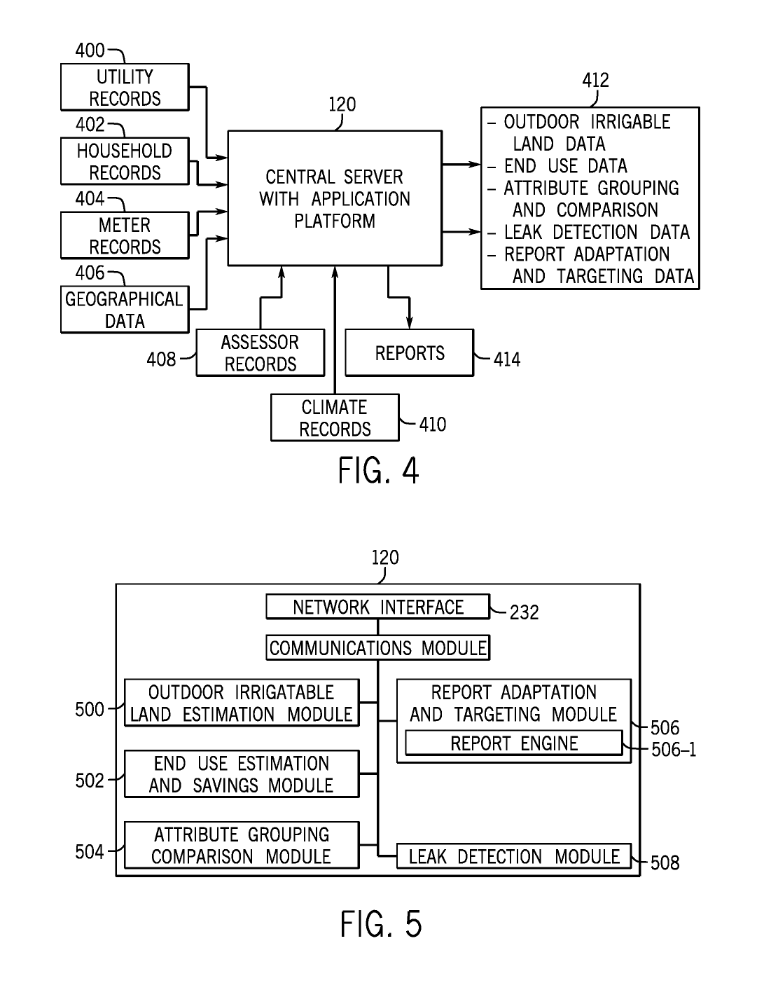

FIG. 4 depicts a high-level block diagram of the flow of data for through the central server of FIG. 1 for generating water usage data (information). The central server 120 receives data such as utility records 400, household (residential) records, meter records, geographical data, assessor records, appliance records, electricity and gas meter records and/or climate records to generate water usage data 412 and reports 414 for one or more occupants of one or more households or other users. The generated data includes outdoor irrigable land data, end use data, attribute grouping and comparison data, leak detection data and report adaption and targeting data and other data known to those skilled in the art.

In accordance with another embodiment, FIG. 5 depicts several software modules of central server 120. Each module is comprises one or more steps for execution by one or more processors within the central server 120 as known to those skilled in the art. These software modules include outdoor irrigable land estimation module 500, end use estimation and savings module 502, attribute grouping and comparison module 504, report adaptation and targeting module 506 and leak detection module 508. The outdoor irrigable land estimation module 502 is a module that actually estimates an outdoor irrigable area in order to facilitate comparison to similar homes and to analyze outdoor water-application rates on a per-area basis. The end use estimation and savings module 502 estimates the water usage of end uses and estimates the savings for implementing potential changes to behaviors and appliances that affect such end uses. Attribute grouping and comparison module 504 aggregates water use data in groups of similar homes to provide benchmarks of median and efficient water use, for comparison purposes. The report adaptation and targeting module 506 generates personalized and targeted reports to home users about their water use and efficiency recommendations. The report module 506 includes a report engine 506-1 for initiating and running the report module. Leak detection module 508 analyzes and identifies water leaks within a household (home) for those households (homes) with automated meter infrastructure (AMI) (or, smart-meters). The steps of the modules are described in more detail below. While these modules are described and shown as part of central server 120, those skilled in the art know that such modules may be stored and executed on multiple servers located in one location or at various different locations from each other connected via the network 150. These multiple servers may be called a central system.

Outdoor irrigable land estimation module 500.

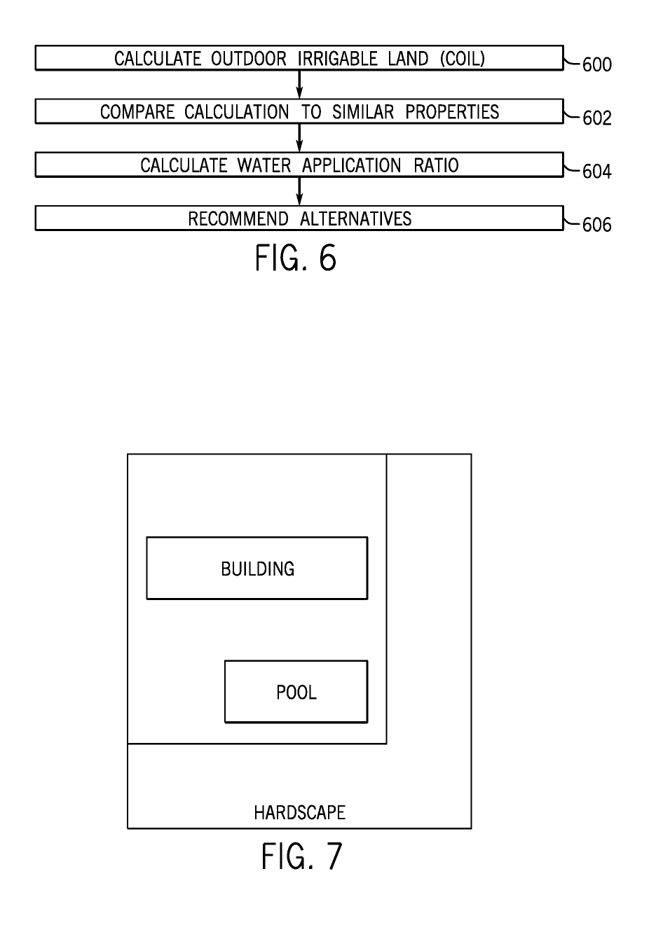

FIG. 6 depicts the high-level method steps of the outdoor irrigable land estimation module 500 of the central server 120 of FIG. 1. As indicated above, outdoor irrigable area is estimated or calculated in order to compare households with similar outdoor irrigable areas. Execution of the method begins at step 600 wherein outdoor irrigable land is calculated using the Coil algorithm/formula below (COIL=“calculated outdoor irrigable land”).

$${Coil}_{raw} = G * MAX ( [ {LotSize}_{calc} - ( \frac{1}{{NumFloors}_{ calc}} * {FinishedSqFt}_{calc} ) ] \\ COIL = Round ( {Coil}_{raw} / 100 ) * 100$$

Coil_{raw} is a raw or calculated value using the formula above. COIL is used to normalize or convert the Coil_{raw} value into a number that is more easily understood for business. That is, COIL will divide the Coil_{raw} value by 100, round off that number to remove the decimals and then multiple it by 100. The Coil_{raw} formula will generally be referred to hereinafter as Coil or COIL unless stated otherwise.

The following variables are calculated and used in the Coil_{raw} formula above.

G=YardScapeFactor_{utility}. “G” represents the amount of remaining property that is not covered by hardscape, shrubs or trees. It is selected by empirical evidence for utilities. 0.7 (70%) is reasonable estimate for residential or suburban properties. More detail appears below.

NumFloors_{calc}=ifnull(NumFloors_{known}, t). This is the number of floors (selected). The number of floors is typically known from the household occupant data (NumFloors_{known}). If the number of floors is unknown (“ifnull”), the number of floors will be assumed (selected) to be the number of floors obtained from a community expert or a number received from the utility directly (“t” as indicated below). 1.5 floors is typically used.

t=NumberFloorFactor_{utility}. This is the number of floors provided by the utility. More details appear below.

LotSize_{calc}=ifnull(LotSize_{residence}, LotSize_{median}) This is lot size (selected). If the lot size is not known (null), then the median lot size (LotSize_{median} below) is used. The lot size is obtained from a household occupant, assessors parcel data, utility data, or other similar source.

LotSize_{median}=P_{RTG}*[Median of Lot Size at each (ZipCode, ResidenceTypeGroup)]. This is median lot size. The median lot size is calculated using known statistical methods for median calculations for each zipcode and residence type group (ResidenceTypeGroup). Using the constant P_{RTG}, the median lot size can be adjusted or over-ridden (i.e., set to zero) for property types (such as condominiums, apartments, and mobile homes) where it is not expected that property residents are directly responsible for irrigating outdoor landscape.

FinishedSqFt_{median}=[Median of Finished Square Footage at each (ZipCode, ResidenceTypeGroup)]. This is the median finished square footage. The median square footage is calculated using known calculations for each zipcode and residence type group. (Example of median: The square footage of all properties within a zipcode and residence type group are gathered and placed in a list, sorted, and the middle number or average of the two middle numbers are used as the median).

P_{RTG}=ResidenceTypeGroupFactor_{utility/RTG}. As described above, this value should be 1 or 0 depending on the property type. For example, zero is for property types (such as condominiums, apartments, and mobile homes) where it is not expected that property residents are directly responsible for irrigating outdoor landscape. P_{RTG} is provided by the utility.

“MAX[ . . . ]” refers to the comparison of the “lot size minus a building footprint” against zero. If the building footprint is larger than the lot size, then “lot size minus building footprint” would be a negative number. Thus, the maximum of that number and zero would be zero. The purpose of the “MAX[ . . . ]” is to ensure that COIL is never a negative value.

Coil recognizes that residence type is an important variable in the analysis of lot size and finished square footage and zip code is an important variable to lot size. Lot size, building square footage and number of building floors information/data is obtained directly from the homeowner and/or county assessors' offices. If these values are not known, the median values from the home's zip code provides a reasonable substitution.

In more detail than described above, with Coil, there are three important constants. First, “G” is the fractional percent of the outdoor area that is actually irrigable. This irrigable area excludes hardscape such as patio, pavement, cement, etc. FIG. 7 depicts a block diagram wherein a lot of land is shown including building and pool structures and hardscape. This value is greater than 0 but less than or equal to 1. This should be tunable for a given utility and set to 0.7 initially (to start) when a property does not have a pool and 0.5 when a property has a pool. That is, approximately 70% (0.7) of the footprint constitutes the lot size (LotSize_{residence}).

Second, “t” is the average number of floors for a household supplied by a utility. This could be tunable for a given utility and set initially to 1.5 (to start).

Third, “P_{RTG}” is an adjustment factor. This value enables a user to adjust the lot size medians for condominiums and mobile homes manually. For a residence type (condominiums, mobile homes), this variable is set to 0 while for all other residence types, the variable is set to 1.

As indicated above, when lot size or square footage is not available, a fallback value is used as a replacement for actual values. Median values or calculations or an adjusted value is used for optimal results. For the Coil formula, the ZipCode and ResidenceTypeGroup are used to determine the median. Alternatively, a median could be determined using a street-level or adjacency grouping. ResidenceTypeGroup is intended to allow grouping of residence/home types that are likely to have a similar amount of outdoor space.

Several examples computing Coil to calculate estimated irrigable area are set for the below.

### Example 1

Known Data—Home: LotSize=10000, Finished Square Footage (SqFt)=2700, Number of Floors (NumFloors)=2, Residence Type (ResType)=1 (Single Family Home—“SFH”). Coil_{raw}=6055 and COIL=6100.

### Example 2

Missing Data—Home: LotSize=10000, Finished SqFt=NULL (0), NumFloors=NULL, ResType=1 (SFH), FinishedSqFt_{calc}=3430 (Median for 94705, Homes), NumFloor_{calc}=1.5, coil raw=5399, COIL=5400.

Coil is a formula described above that more quickly and inexpensively calculates irrigable area (“grass”) than prior systems or processes such as satellite with infrared imagery.

Returning to FIG. 6, execution moves to step 602 wherein the COIL calculation is compared to similar properties. That is, a comparison is made of similar residence, number of occupants, geography etc. Coil enables an occupant or other user to compare its data with households having similar data.

Execution then moves to step 604 wherein water application ratio is calculated. This is the outdoor usage in gallons per square foot of a given property. The water application ratio is one of many important inputs that the central server 120 uses to make recommendation or suggestions for future water usage at step 606. Steps 602-606 are also part of module 500 as shown in FIG. 6. Coil enables the central server 120 to fairly group similar homes and thus enable a user to determine how well his/her household is behaving in comparison to others.

End Use Estimation and Savings Module 502.

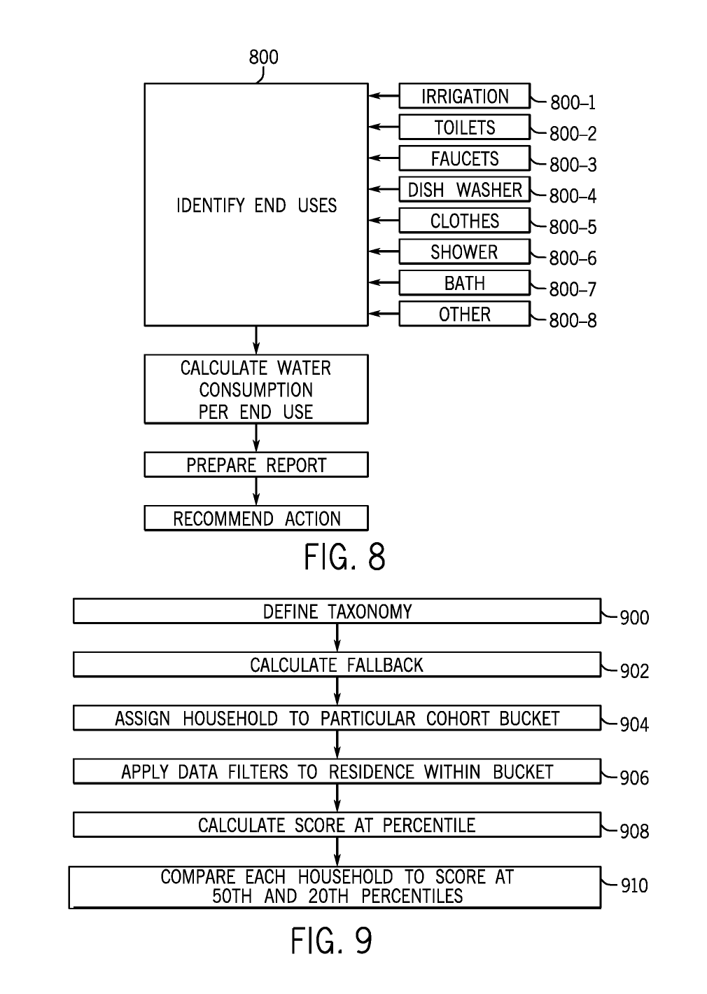

The end use estimation and savings module 502 estimates the water usage of end uses and the savings for implementing potential changes to such end uses. FIG. 8 depicts the high-level steps of end use estimation and savings module 502 in the central server 120. Water usage is estimated for each end use such as a faucet. Specifically, execution begins with step 800 wherein end uses are identified. Such end uses include outdoor irrigation 800-1, toilet 800-2, faucet 800-3, dish washer 800-4, clothes washer 800-5 and other uses 800-6 known to those skilled in the art. For each end use estimation, several parameters are taken into consideration relating to a household. For indoor use as an example, these parameters include number of occupants, amount of water for an appliance and number of times an appliance is used. The estimations recognize, based on prior studies, however, that the number of occupants does not linearly affect such estimations. This is reflected in the estimations below for each end use.

Execution moves to step 802 wherein water consumption is calculated per end use. These end uses follow.

Toilets and Urinals as an End Use.

Toilet consumption is estimated for the number of gallons per year used by a toilet (“Toilet Gallons Per Year”). This is accomplished by calculating the toilet gallons for a single occupant and then non-linearly scaling the gallons for the number of occupants in the house. The non-linear scaling is done because it is recognized that the volume of toilet gallons does not increase linearly with the number of occupants as described above. The Toilet end use calculation is as follows: Toilet Gallons Per Year=[0.69*NumOccupants^{0.61}*AvgToiletGallonsPerUse^{0.86}*HouseSize^{0.32}−6.79*KidsLivingAtHome+7.06*AdultPrimarilyAtHome]*365 (days per year) whereby “NumOccupants” is number of occupants, “AvgToiletGallonsPerUse” is average toilet gallons per user, and “KidsLivingAtHome” is Kids living at home, and “AdultPrimarilyAtHome” is Adult living at home.

The calculation sets KidsLivingAtHome and AdultPrimarilyAtHome to zero by default (FALSE) unless the number of kids and/or number of adults staying at home during the day are known (by occupant answers to posted questions (and stored to a consumer or other database with household profiles)).

“HouseSize” (house size) is the square footage of the house. To avoid data errors and legitimate outliers from skewing the results of this calculation, the square footage is bounded. A minimum number between 900 and 2500 is used. Although there are homes that are legitimately larger than 2500 or smaller than 900, these values are used to maintain the model within reasonable limits. When savings are calculated for providing improvement tips related to toilet use, the savings number is also scaled for the number of occupants so as to avoid overstating the estimated savings. For the recommended saving tips, toilet gallons per year (ToiletGallonsPerYear) for the household is recalculated using the above formula, but AvgToiletGallonsPerUse is replaced with the average associated with each tip. For example, when calculating the savings for upgrading to high efficiency (HE) toilets, 1.28 is used for AvgToiletGallons where 1.28 is the Gallons Per Flush of the high efficiency (HE) toilet.

While recommendations or tips have not been discussed in this process yet, there are many recommendations that may be used. For example, a recommendation for reducing toilet water usage may include a tip called flush one less time per day. For this tip, it is assumed that each occupant in the household flushes one less time per day which would result in an annual savings of AvgToiletGallonsPerUse*NumOccupants*365. The following table lists several examples of tips and changes to implement by the household (i.e., occupants). There are many other tips as set forth in the table below.

| TIP NAME | | CHANGE RECOMMENDED |
|---|---|---|
| (1) | Upgrade to ULF toilets | The variable ULFGallonsPerUse, |
| | | currently 1.6, should be used in place of |
| | | AvgToiletGallonsPerUse to determine |
| | | Tip Gallons |
| (2) | Upgrade to HE toilets | The variable HEGallonsPerUse, |
| | | currently 1.28, should be used in place |
| | | of AvgToiletGallonsPerUse to determine |
| | | Tip Gallons |
| (3) | Install toilet displacement | AvgToiletGallonsPerUse should be |
| | device | reduced by |
| | | ToiletDisplacementGallonsSaved |
| (4) | Install toilet displacement | Savings should be equal to |
| | | AvgToiletGallonsPerUse * |
| | | NumOccupants * 365 |

Kids or teens in the house play a factor in the algorithm. Kids or teens reduce the estimate of total indoor water use by a significant amount as known to those skilled in the art. However, the number of kids or teens is not important as part of the algorithm. The presence of kids reduces water use by 26 gallons per day while the absence of kids increases average water use by 15 gallons per day. It also increases toilet use by 6.79 gallons per day. Household profile will thus include data concerning the occupants that have an age of less than 18 years old. If there is an occupant less than 18 years of age, this will affect water usage. Employment also affects water end usage. An occupant that is not employed outside the home will increase toilet usage by about 7.06 gallons per day. The household will be provide occupant age range and employment status information via survey or other mechanism as discussed above. In addition, a household will provide toilet flow rate information if available in order to help illustrate water end use comparisons for using new current toilet models. If urinals are used, they are used only for a limited time and only by males. Therefore, the formula for urinals would be a function of number of male guests (or percentage) and other parameters known to those skilled in the art.

Faucets as an End Use. Faucet water usage is estimated by calculating the average gallons per day (GPD) of faucet use. Accordingly, the algorithm for average faucet gallons per day (GPD) is: 22*Residents^{0.7206}*(AvgFaucetDuration/60)*AvgFaucetFlowRate*ThrottleRate. Average faucet duration (AvgFaucetDuration) is 37 seconds, throttle rate (ThrottleRate) is 0.90 and average faucet flow rate (AvgFaucetFlowRate) is derived from assumptions about the age of the home and/or fixtures or data the resident provides through a household profile survey. Conventional faucet flow rate is 5 gallons per minute (gpm), low flow (LF) faucet flow rate is 2.75 gpm, and Ultra Low Flow (ULF) or aerator flow rate is 1 gpm and throttle rate=90%. These values are known to those skilled in the art. The constants used to determine faucet events (22*Residents^{0.7206}=number of times a faucet is used during the day) in the algorithm above were determined by curve fitting data to create the algorithm from known parameters and water usage from the Aquacraft model from the California Single Family Water Use Efficiency Study (Deoreo, 2011) as known to those skilled in the art. This is described in more detail below.

In the Aquacraft model, faucet gallons per day in the average efficient home is modeled as follows: Faucet GPD=5.54*Residents^{0.44}*FlushesPerDay^{0.46}, where Faucet GPD is the average daily gallons of faucet use. “Residents” is the number of full-time residents in the house and FlushesPerDay is the average daily number of toilet flushes. The faucet use is a function of the number of residents and the faucet flow rate. It is assumed that FlushesPerDay can be calculated by using the toilet algorithm above, which is a function of the number of residents, the number of adults home during the day (zero), the number of children living at home (zero), and the square footage of the house (1800). Plugging the above assumptions into the Aquacraft model, data is obtained concerning the number of occupants, average flushes per person per day (pppd) and gallons per household per day (GPHD) according to the Aquacraft study.

Next, other assumptions and averages found in the Aquacraft study are used to determine the number of faucet events per day (faucet uses), which is then incorporated into the faucet algorithm described above. The Aquacraft study finds that the average volume of a faucet event is 0.6 gallons. If the faucet GPHD is divided by 0.6, the number of faucet events is found for various number of occupants per gallons per household per day (GPHD) (according to the Aquacraft model). As described above, a curve is fitted to derive the number of faucet events as a function of the number of occupants. The curve is y=22x^{0.7206} and has an R-squared value of 1 where “x” is the number of occupants. This model is used for the number of faucet events (i.e., faucet use occurrences). The number of events is multiplied by the flow rate and length of the event. These flow rates and throttle rates are known to those skilled in the art (Pacific Institute, WECalc (wecalc.org) and Trends in Shower Design and Their Effect on Energy and Water Use, Biermayer 2006)). Other faucet statistics include average duration of faucet event (37 seconds) and average peak flow faucet event (1.1 gpm).

In summary, it is desired that the faucet gallons be a function of the number of faucet events, the length of the average faucet event and the flow rate of the faucet. The output of the Aquacraft model and include other assumptions found in the Aquacraft data to create the algorithm (for average gallons per day (GPD) of faucet use) that uses faucet flow rate as an input above.

Clothes Washer and Dishwasher Water Usage.

In prior methods, water usage estimation for a clothes washer is based on gallons per load and multiplying it by a fixed number of loads per person per day. In order to improve this estimation, the function of number of occupants and the gallons per load are incorporated in the algorithm. In addition, the algorithm recognizes that the calculation does not scale linearly as a result of occupancy data (discussed above). If an occupant does not have a clothes washer, usage for the faucet increases, as this correlation is shown clearly in the Aquacraft data. The absence of a dishwasher increases faucet use by about 14 gallons per day. In view of this, to calculate the number of clothes washer gallons per day, the following algorithm is used: 1.31*NumOccupants^{0.58}*GallonsPerLoad^{0.70} (Aquacraft's California Single Family Use efficiency Study 2011) whereby NumOccupants are the number of occupants and GallonsPerLoad are the number of gallons per load. The gallons per load will change for the conventional and high efficiency clothes washers. For conventional clothes washers, the average gallons per load should be 40. For high efficiency, the average gallons for load should be 20. These adjustments are known to those skilled in the art (from the California Energy Commission).

As for clothes washer tips, when calculating the savings for upgrading to a high efficiency HE washer, calculate the tip gallons using the algorithm above and then compare to the baseline clothes washer gallons. When calculating the savings for fully loading the washer, apply the load reduction to the total clothes Washer Gallons instead of the number of loads. The effect will be the same. We need to change the text so it's clear we are suggesting a 25% decrease in the number of loads.

The dishwasher algorithm is a function of the number of occupants in the household and the age of the dishwasher. The formula for Dishwasher Gallons Per Day is Number of Uses Per Person Per Day*NumOccupants*Dishwasher Gallons Per Use, whereby the “Number of Uses Per Person Per Day” is 0.15, the “Dishwasher Gallons Per Use” is either 15 gallons for conventional dishwashers or 4.1 gallons for high efficiency (HE) dishwashers.

For households without a dishwasher, faucet use is increased by the following formula to account for hand washing of dishes. This algorithm is Hand Washing Dishes GPD=14*NumOccupants^{0.1} gpd for faucet use (to account for hand washing of dishes).

From the Alliance for Water Efficiency, “Studies have found that dishwashers are used between 0.1 and 0.2 times per person per day.” For the dish washer algorithm, the difference is split and used 0.15. http://www.allianceforwaterefficiency.org/Residential_Dishwasher_Introduction.aspx

For the Gallons Per Use for Conventional Dishwashers (15) and high efficiencey (HE) Dishwashers (4.1), the averages are based on data found in Vickers, Amy (2001) Handbook of Water Use and Conservation and ENERGY STAR, Dishwasher Key Product Criteria.

Based on Aquacraft's California Single Family Water Use Efficiency Study (2011), the presence of a dishwasher decreases per capita indoor use by approximately 14 gallons per day. To derive the exponent used in the hand washing algorithm above, the exponent is adjusted so that the excess gallons per day for any number of occupants was about 14 gpd as compared to a household having a high efficiency (HE) dishwasher. The intent was for this number to vary with the number of occupants in the house. The value of 0.1 provided the best fit but those skilled in the art know that other values will work.

In addition, a new tip for installing a high efficiency (HE) dishwasher may be used but only for those that do not currently have a dishwasher. To calculate the savings for this tip, compare the gallons used by an HE dishwasher for the number of occupants in the house to 14 gpd, which is our estimate of how many gallons are used for hand washing dishes. In other words, if a household of two people does not have a dishwasher, the calculation savings (for this tip) is: 0.15*(NumOccupants)*HEDishwasherGallonsPerUse−14GPDforHandWashing. 0.15 is the current value for number of loads per person per day. 4.1 is the current value for HEDishwasherGallonsPerUse. (HEDishwasher—high efficiency dishwasher).

Shower.

For this calculation the goal is a model shower gallons as a non-linear function of number of occupants and showerhead flow rate. In addition, showerhead flow rate and shower length or frequency of showers is important. To this end, the algorithm for estimating shower water as an end use is the following: ShowerGallonsPerHousePerDay=AvgShowerFlowRate*AvgShowerThrottleRate*AvgShowerLength*AvgShowersPerDay*NumOccupants^{0.84}, whereby the following variables are used for the algorithm.

(1) AvgShowerFlowRate is the average shower flow rate for the household based on age of fixture.

(2) AvgShowerThrottleRate is the average shower throttle rate and it is the average percentage of full-blast the shower is run. This value is set at 0.9

(3) AvgShowerLength is the average shower length and it is set to 8.

(4) AvgShowersPerDay is the average showers per day and it is set at AvgShowersPerPersonPerWeek/7.

(5) AvgShowersPerPersonPerWeek is the average showers per person per week and it is set at 5.

(6) Conventional Shower Head Flow Rate is set at 5 gpm.

(7) Low Flow (LF) Shower Head Flow Rate is set at 2.5 gpm.

(8) Ultra Low Flow (ULF) Shower Head Flow Rate is set at 2.0 gpm.

Variables and constant values described above are derived or obtained from known sources (e.g., Aquacraft study—Single Family Water Use Efficiency Study, DeOreo, 2011 and ShowerGallonsPerHouseholdPerDay=3.49*Occupants^{0.84}*Income^{0.27} and Potential Water and Energy Savings from Showerheads by CUWCC and Lawrence Berkeley National Lab, Peter Biermayer, 2006). In this study, income is annual household income in units of $1000. In order to improve accuracy, “showerhead flow rate” and “length of shower or frequency of shower” are incorporated. These values are derived back from the Aquacraft algorithm (Single Family Water Use Efficiency Study, DeOreo, 2011) model. Other statistics from the study and income set at $80,000 are $80,000 for annual income is used to approximate these numbers. In other words, 3.49*1^{0.84}*80^{0.27} is 11.4 gallons per day. It is assumed that 11.4 gallons per day is for a person who takes 5 showers per week, each 8 minutes in duration. Then, the flow rate is 1.99. Then, the algorithm in accordance with an embodiment of the invention is created as: ShowerGallonsPerHousePerDay set forth above.

Once shower usage is determined, shower tips changes are offered. For example, it might suggest that the occupant upgrade to ULF showerhead and use 2.0 gpm as the flow rate. Other tips include “shorten showers to 5 minutes”, “change the Average Shower Length to 5 minutes”, or “reuse cold shower water” (assume cold shower water is 27% percent of overall shower water (according to Aquacraft's Disaggregated Hot Water Use in Single Family Homes from 2001 which says 73% of shower use is hot water).

Irrigation as an End Use.

Outdoor irrigation is an important part of the overall yearly water usage. However, sufficient data is not always available to calculate or estimate outdoor use. If such data is available outdoor irrigation usage is calculated for display. If not overall yearly water usage would consist of indoor only end uses.

When data is available, annual outdoor usage is calculated as follows: Annual Outdoor Usage=Annual Irrigation+Annual Pool/Spa. In order to calculate annual irrigation, the total annual usage (tYR) from meter readings are obtained for the months during which the occupant irrigates. If this data is not known, other usage information is obtained. Irrigation is estimated by using average daily indoor usage (iAVG). Thus, annual irrigation (iYR)=tYR−iAVG*NumUsageDays. The NumUsageDays=MIN(365, total days for which we have usage data for the occupant if less than one year). In other words, the number usage days equals the minimum of 365 days or the total days for which usage data exists for an occupant if less than one year. There are several different states an occupant may reside. This information will be used to estimate outdoor use. In some circumstances, additional information may be desired and central server 132 will prompt the occupant enter such information for improved accuracy.

Household profile questions will generate data to be used in the algorithm. Requests concerning outdoors irrigation will generate answers about yearly usage. For example, an occupant may respond that she irrigates all year around or during the winter.

Bath as end use. Water use for baths is also a part of an occupant's overall yearly use. To this end, yearly bath usage is calculated as follows: BathsPerPersonPerDay*BathGallonsPerUse*NumOccupants*365. BathsPerPersonPerDay is the number of baths taken per person per day. The default should be by survey data. Alternatively, this variable may be set to 0.14 (assumes one bath per week) as known to those skilled in the art (Seattle Home Water Conservation, 2000 (www.cuwcc.org/WorkArea/downloadasset.aspx?id=12152). BathGallonsPerUse is set to 24 as known to those skilled in the art. http://www.green3dhome.com/YourHouse/Bathroom/Bathtub.aspx.

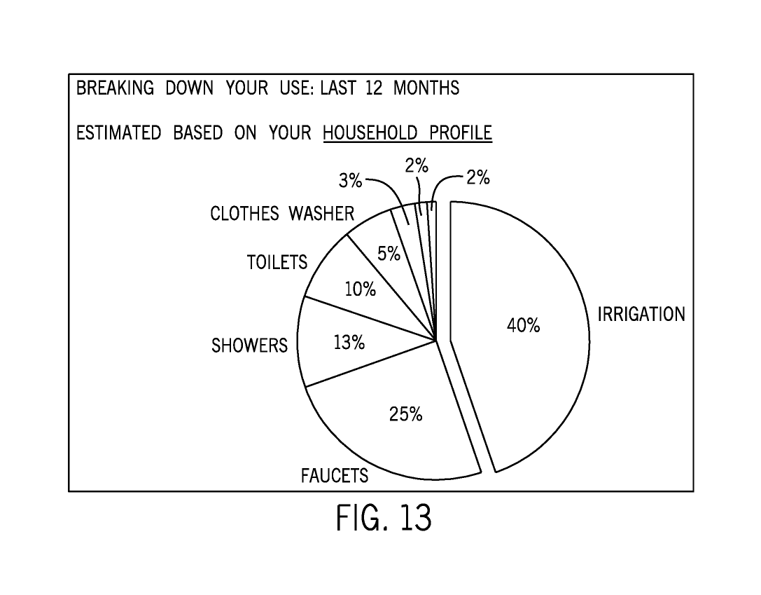

Returning to the flowchart steps of module 502, execution moves to steps 804 and 806 wherein a report is prepared along with a recommended action. The report typically is a pie chart which breaks down yearly water usage by slices for end water use. FIG. 13 provides a pie chart wherein an estimate of how and where water is being used in a household. The recommendations or tips for changes may be in the form as identified above with respect to each end use. There may be tips for savings based on usage model. For example, if an occupant (user) has an older-model toilet, the system will advise that he/she will save approximately 40 GPD and $200/year if the occupant uses a different toilet. Central server 120 has a library of ways to save money and reduce water usage. The central server 120 can categorize and present the library by a number of arbitrary tags including but not limited to “indoor”, “outdoor”, “rebate available”, “free”, “recommended”, etc., This library may be stored in the consumer or other database 134 or recommendation module 246. Central server 120 will make recommendations that are personalized to an occupant/user.

Attribute Grouping Comparison Module 504.

The attribute grouping comparison module 504 is used to socially group or aggregate like households with similar attributes in order compare water usage data within that group. That is, this module enables the comparison of usage data by various attributes (e.g., occupants, location, property). For example, since indoor usage is driven by occupants, while outdoor water usage is driven by irrigable area, an “apples-to-apples” comparison of homes requires both (and other) factors to be considered. By such comparison, the attribute grouping comparison module 504 provides median and efficient water usage values for a given water usage reading period (date period) for a variety of groups or “cohort buckets” within an aggregate taxonomy (classification system). The taxonomy describes the matrix axes for a system of cohort buckets. A cohort is a way to describe all intersecting attributes of a group of households. Said differently, cohort is a specific point in a taxonomy matrix. For purposes of this discussion, a taxonomy may include the following parameters: household/residence type, occupant number, lot size, amount of irrigable area, zipcode, income and other parameters such water-pressure zones, latitude/longitude ranges, and other attributes as known to those skilled in the art. For example, if the taxonomy is “household/residence type, number of occupants and amount of irrigable area”, then a cohort bucket may be “condominiums, with 3 occupants, and 1000-2000 square feet of irrigable area”. The median usage value is by definition the water use (GPD) at the 50th percentile and the efficient usage value is defined as the water use (GPD) at the 20th percentile, but other values may be set for desired comparison as known to those skilled in the art.

FIG. 9 depicts the high-level steps of attribute grouping comparison Module 520. Execution begins at step 900 wherein the taxonomy (classification system) is defined. As indicated above, this classification may include the following parameters: household/residence type, occupant number, lot size, amount of irrigable area, zipcode, income and other parameters such pressure zones, latitude/longitude ranges, presence of swimming pool as known to those skilled in the art. A cohort bucket will exist for all possible combinations of all discrete values (or value ranges) for each of the axes in the taxonomy. In practice there will likely be 30-50 groups of “fair comparisons”.

Execution then moves step 902 wherein a fallback is calculated. Later in the process the household data from one or more databases will be extracted. If data is missing or non-existent, data must be supplied as a fallback, for the purposes of knowing which cohort bucket each some should belong to. For example, if the number of occupants is not available, a fallback such as # of bedrooms is used, and subsequent fallbacks must be defined in case of the absence of that data. As mentioned in the COIL calculations related to outdoor irrigable area, missing data must be replaced with ZipCode/ResidenceTypeGroup medians, and those medians are calculated during this step.

Then, each household/residence is assigned to a particular cohort bucket at execution step 904. As indicated above, a cohort bucket is a way to name a value range or inclusion list of parameters depending upon the bucket. The entire universe of households are examined and sorted into cohort buckets so each household gets assigned to one and only one bucket. A cohort bucket, for example, may a “single family home, 1 occupant and no irrigable area”. A second bucket may be a “single family home, 2 occupants, and no irrigable area: Another cohort bucket may be occupants within a value range for the bucket whereby the minimum and maximum occupant numbers are between 2 and 4 occupants. Another example is a residence type bucket. For example, a cohort bucket may include both condominium and mobile homes. The relationship between a cohort bucket and its required discrete values or value ranges for each of its properties is defined in the central system 120.

Attribute aggregation has aspects of “mutual exclusivity and exhaustiveness.” Consider the case where an account is selected and cohort buckets are identified for such account. Based purely on the bucket definitions, an account could be assigned to an unlimited number of cohort buckets but for business purposes, every account must be assigned to at least one cohort bucket (exhaustive), at least one bucket for the home must be identified as “primary” and the home must not be in any other cohort bucket identified as “primary” (exclusive). For example, it is logical that a home could be in the cohort bucket “Single family homes, 1 resident, 1000-2000 sqft irrigable area” as well as be in the cohort bucket “All types of homes, 1 to 3 residents, 1000-2000 sqft irrigable area.” In this case, it would be likely that the first bucket would be marked as primary and would be part of a set of buckets that included all homes (exhaustive) with no home appearing in more than one bucket (exclusive). The module will enable the configuration of overlapping buckets for customer if desired or effective. Non-overlapping buckets are preferred to make the process less complex. The “primary” bucket is the one generally used by the system for communication with the end-user.

Utilities may also turn off one or more of the matrix dimensions, i.e., data aggregation by a particular parameter. For example, configuration would allow a utility to say that “it does not want to aggregate by number of occupants.” Universal buckets that are invisible to end-users can be used to this purpose, all household accounts may be assigned to this universal bucket so that it is not displayed in any text description of the cohort bucket.

Execution then moves to step 906 wherein filters are applied to a household (i.e., residence) within a bucket. In this step, outlying usage data is removed from mathematical consideration of the aggregation if it appears suspect, i.e., not consistent with other similar data for household usage data pattern (such as having missing water meter reads, or huge or negative numbers presumably indicating a fault with the meter itself). That is, anomalous and erroneous data would affect median data calculations so they are excluded.

Now, execution moves to step 908 wherein percentile scores are calculated. In order to accomplish this, all water usage values for each household within a bucket are aggregated. “Aggregation” is the process of calculating percentile ranks for each and every cohort bucket. Once the percentile rank is determined, the water use at the 50th percentile and the 20th percentile are used over a given period of time for business purposes but those skilled in the art know that other percentile values may be used to achieve desired results. Mathematically, the 50th percentile is the same thing as the median (and it is often identified as “average use” but it is not mathematically the average). The 20th percentile is identified as “Efficient Use.” The 20th percentile represents the amount of water use which only 20% of the households in that particular cohort bucket use the same amount of water or less water. Percentile ranking is a conventional statistical method that is known to those skilled in the art. Gallons per day data (GPD) is typically aggregated but those skilled in the art know that other values may be aggregated in accordance with the cohort buckets. These values are from the historical water usage for each household. These percentiles are calculated on a gallons per day basis, which normalizes the water-meter read data provided in total gallons based on the number of days between water-meter reads. In summary, a typical output of the aggregation step is the “median” and “efficient” use for a given month for all “single family homes with 2 occupants, and a medium sized yard”.

Execution then moves to step 910 wherein these scores of a given household are compared with other households like them and provide one of the many key inputs into the report adaptation and targeting module 506 (below).

Report Adaptation and Targeting Module 506.

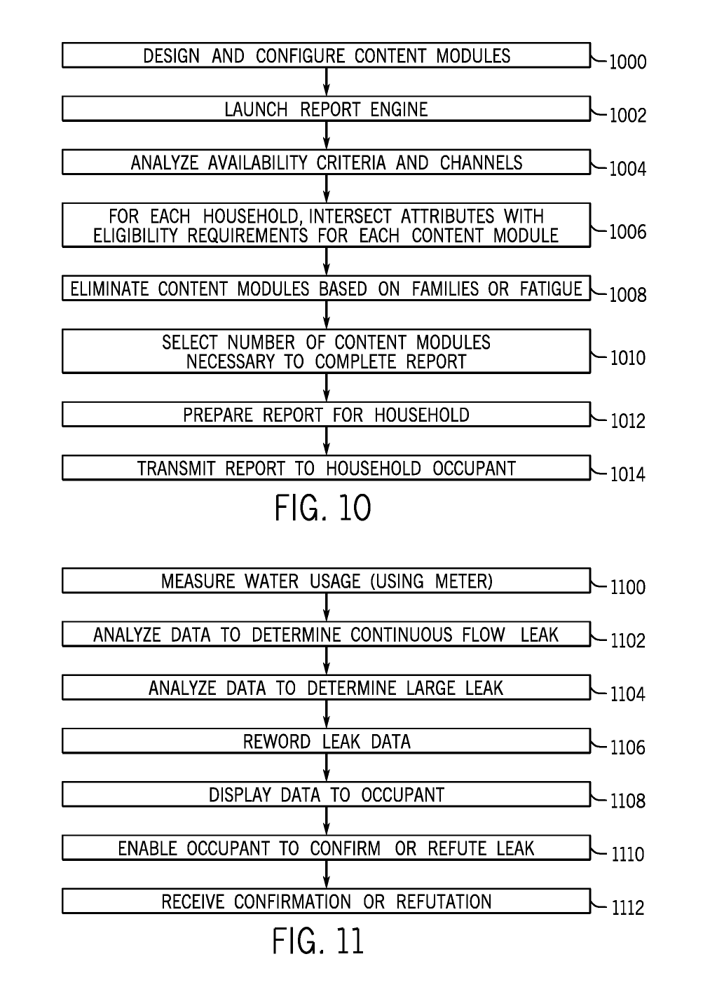

The report adaptation and targeting module 506 provides targeted and adaptive report content preparation for a household. This module 506 is a content modular based household process to prepare reports that are personalized to a household. (The module 506 may incorporate the recommendation module 246.) The module 506 incorporates a report engine that is capable of selecting content modules that are appropriate, timely, and interesting without human intervention. Each report is an amalgamation of many content modules. FIG. 10 depicts the high-level steps of the report adaptation and targeting module 506. Execution begins at step 1000 wherein the content modules are designed and configured. Some examples include layout modules such as utility branding modules, current water use modules such as empathetic gauge module, data insight modules such as annual water consumption module, messaging modules such as leak alert message module, and recommendation action modules such as gallons per day savings module. A more detailed exemplary list of content modules is set forth the rear of this disclosure.

Execution then moves to step 1002 wherein the report engine is launched to generate reports. Next, the report engine will analyze availability criteria and channels for the reports at step 1004. Availability criteria include a date range (in which to display or not to display content modules), phase (in which display is dependent on a recipients level of maturity in the program—on a spectrum of new to mature), and months (in which display is dependent on what month of the year it is)

Availability channels are the number of available ways in which content modules may be sent to an occupant. The ways include email, text, mail, online, web posting and mechanisms known to those skilled in the art. Some content modules, for example, are not available for print or email while other content modules may be preferred or required by a particular medium. For example a coupon may be best for print. Facebook sharing is performed by email or web posting.

Execution then moves to step 1006 wherein attributes of each household are intersected with eligibility requirements for each content module. For example, length of residency, if available will interest modules directed at water usage over length of residency. If an occupant has resided at his current property for only a year, a report will not include the information from the “This Year vs. Last Year” Water Usage module. There are many (50+) such availability criteria including but not limited to “user has irrigation”, “user has high summer use summer irrigator”, “user has a pool”, “user owns the property”, “user is registered online”, “user's house was built prior to 1970”, and so forth. Many additional examples of the availability criteria is set forth in the the rear of this disclosure.

At step 1008, content modules are further restricted to mitigate fatigue based on cool-down and families. Cool-down refers to the number of days a module should wait before it is presented again to a user who has seen it already, in order to minimize negative effect on the recipient. Similarly, each content module is assigned a family to ensure that an occupant does not receive multiple pieces of similar content within the same outreach/communication. A family is assigned by an industry expert to a set of modules that should avoid being shown in the same communiqué. For example, an occupant may receive a recommendation to completely fill a clothes washer for each load, but will not simultaneously receive a recommendation to replace his/her current clothes washer with a front-loading clothes washer, because these modules belong to the same family.

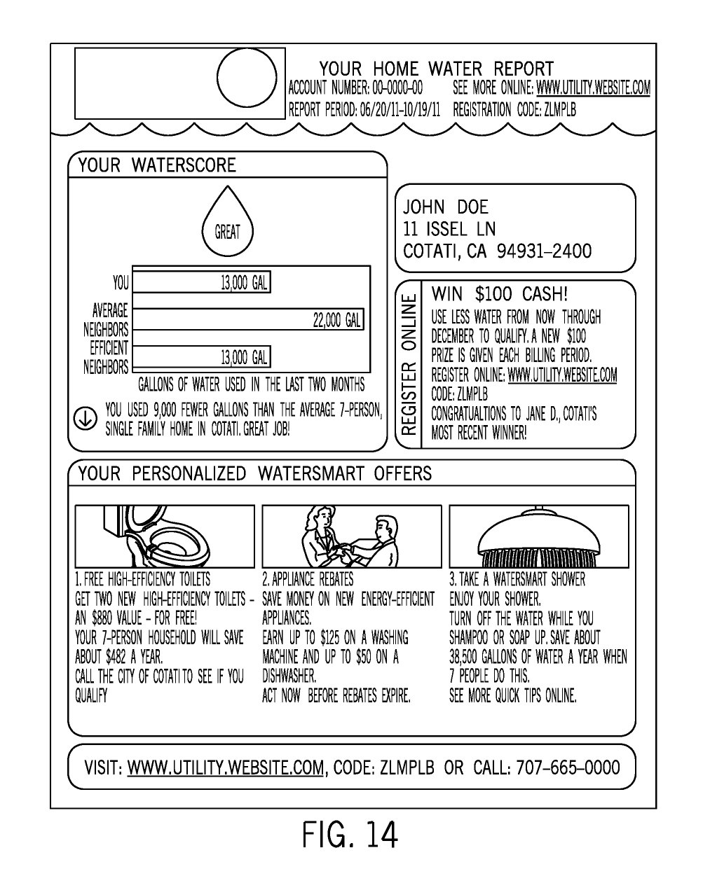

A specific number of various content modules that are necessary to complete a specific report template are then selected. For example, a report might need one “WaterScore module”, one “data-insight/graphical module”, two “message modules”, and three “water-savings/recommendation modules”. At execution step 1010 a report is prepared at step 1012. FIGS. 14, 15 and 16A-16B provide examples of two printed water reports and an emailed home water report as provided by a customer engagement platform for water-use efficiency. More details appear below.

Leak Detection Module 508.

The leak detection module 508 detects and estimates water loss due to a leak at a household equipped with Advanced Meter Infrastructure (AMI) (i.e., smart-meter). FIG. 11 depicts the high-level process steps of the leak detection module 508. The process begins at step 1100 wherein water usage is measured. As known to those skilled in the art, water usage through a smart meter is measured at frequent intervals (e.g., hourly). Then, the data is analyzed to determine whether a household is experiencing a continuous flow leak at step 1102. Similarly, the data is analyzed to determine whether a household is experiencing a large leak at step 1104. If a leak is determined, the method calculates/records leak data such as date, detection, date, flow rate, total water lost, percentage of total water use and end date at step 1106. This data is displayed or transmitted to an occupant at step 1108. In one embodiment, an occupant is enabled to confirm or refute the whether the occupant's household is experiencing a leak at step 1110. At step 1112, the confirmation or refutation is received.

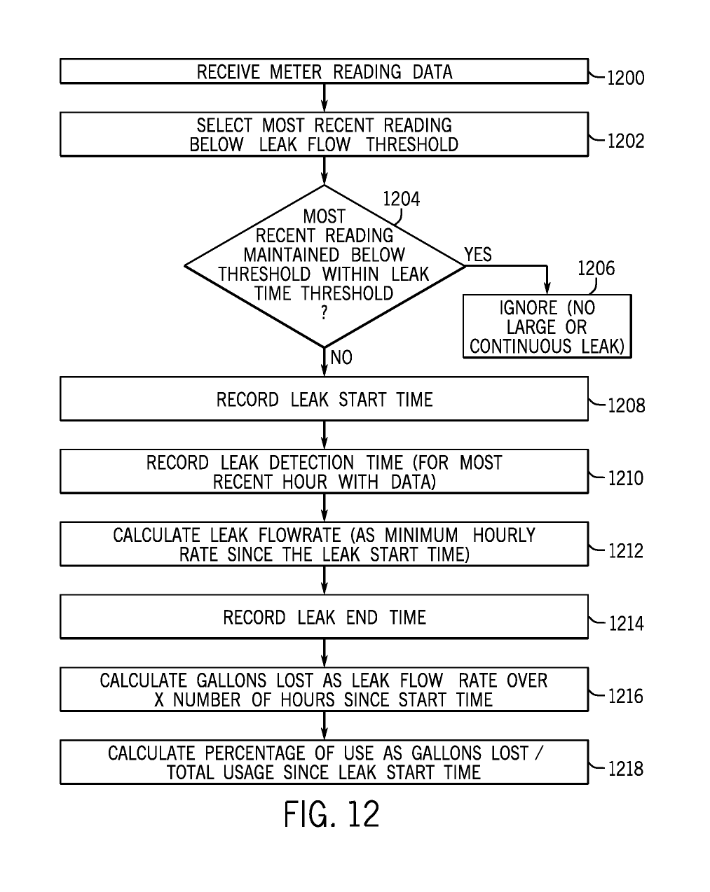

FIG. 12 depicts detailed process steps of the leak detection module 508. Similar to the process in FIG. 11, the process begins at step 1200 wherein meter reading data is received. As indicated, meter readings are frequently taken with a smart meter located on or in proximity to an occupant's property. Typical meter readings are sensed hourly. The data received is analyzed and the most recent readings below a leak flow threshold is selected at step 1202. Leak flow threshold should be constant for each utility and is commonly set to 10 Cubic Feet (CF) for large leak detection and set to zero for continuous flow detection.

The process moves to step 1204 wherein it is determined whether the most recent reading is maintained below a leak flow threshold for a leak time threshold. A leak time threshold is the amount of time in which continuous flow constitutes a leak. This should be constant for each utility. Leak threshold is commonly set to 6 hours for large leaks and 72 hours for a continuous flow leak, but those skilled in the art know that other values will work as desired.

If the most recent reading is maintained below a flow threshold for a set period of time, then the home is deemed ineligible for a leak event (no large or continuous leak found) at step 1206.

If the most recent reading is not maintained below a flow threshold for a set period of time, then a leak is detected and the process proceeds to steps 1208 and 1210 wherein the leak start time and leak detection time (for most recent hour with data) are recorded, respectively. The process then moves to steps 1212 wherein leak flow rate is calculated as a minimum hourly rate since the leak start time). Then, leak end time is detected at step 1214. The process moves to step 1216 wherein the gallons lost is detected as leak flow rate over the number of hours since start time. The process finally moves to step 1218 wherein the percentage of use is calculated as gallons lost/total usage since the leak start time. Occupants may be notified of leak detection by several mechanisms as described herein for notification (e.g., email, text message, call).

As indicated above with respect to the report adaptation and targeting module 506, FIGS. 14, 15 and 16A-16B provide examples of two printed water reports and an emailed home water report as provided by a customer engagement platform for water-use efficiency.

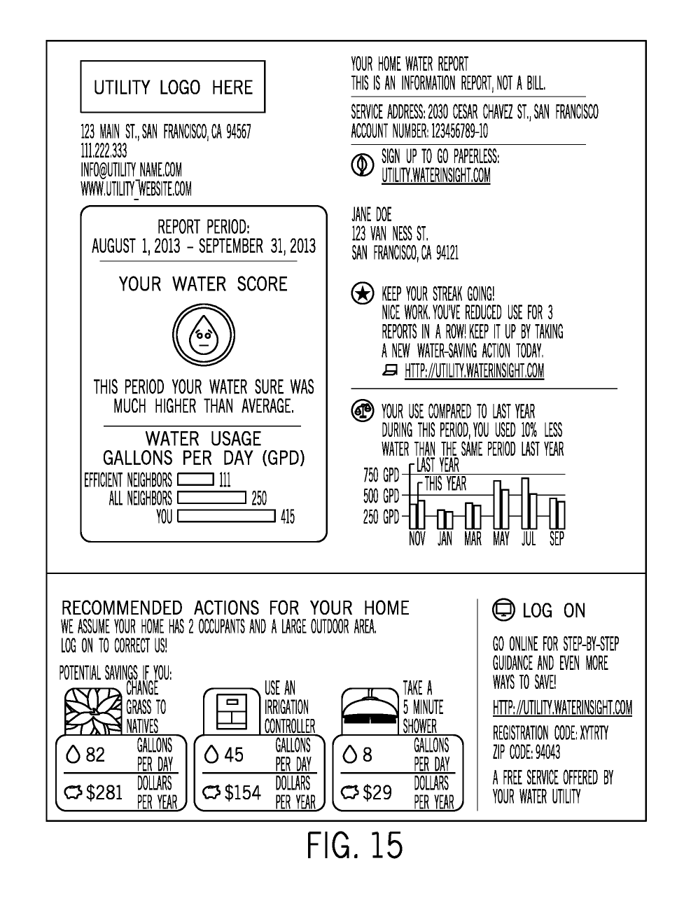

In the embodiments in FIGS. 14 and 15, the water reports provided by the system contains features relating to: water-use consumption, a WaterScore (e.g., per billing period), water-use comparisons among similarly-sized households, personalized ways to save, URL/link to a web-based customer portal and if needed, a unique registration code, promotions such as incentives, rebates, promotions, and/or other content related to water-use efficiency, URL/link to encourage consumers to sign-up for emails, indoor and outdoor water-use estimates, and URL/link to individual ways to save. In some embodiments, the water reports include availability and/or value of a public utility's incentive or rebate program, customized descriptions for each of the personalized ways to save, up to three customized offers in the promotion section, a comparison to a consumer's water allocation or budget, and program participation data for individual households.

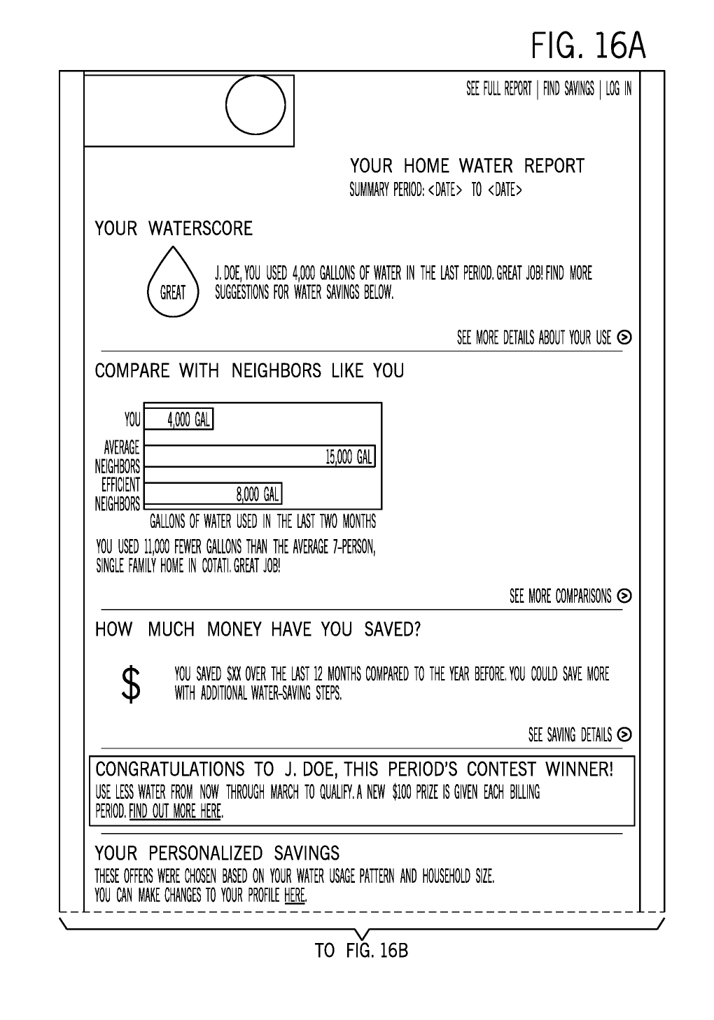

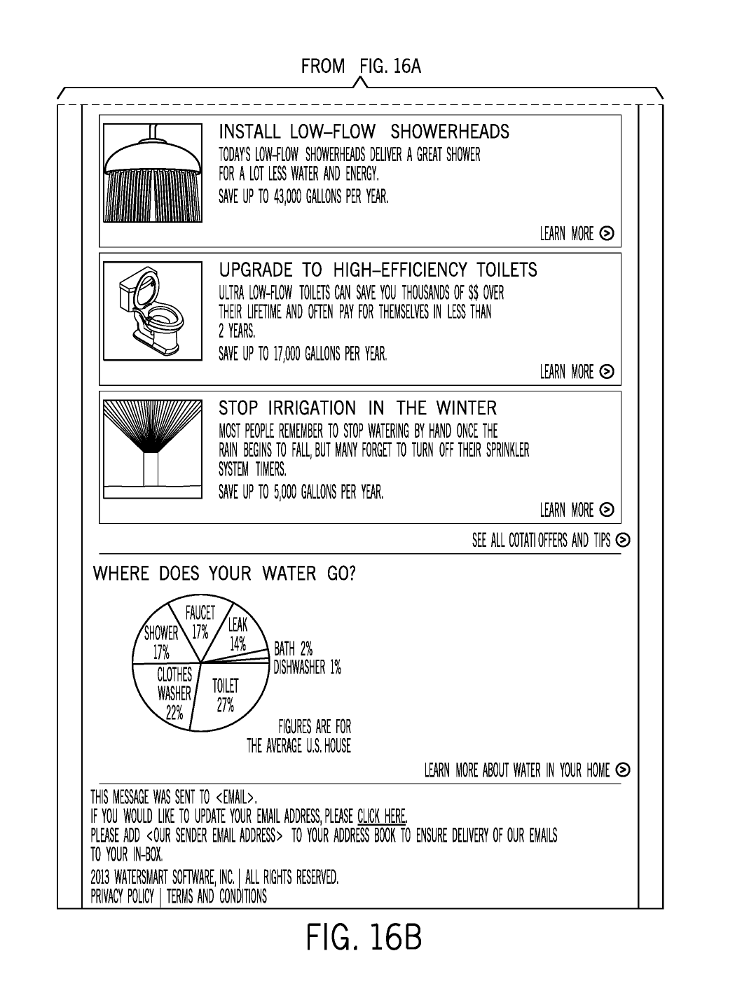

In one embodiment as shown in FIGS. 16A-16B, the system implements mobile messaging and/or other forms of content delivery to customers. Such messaging may include weather alerts, event reminders, consumption-related messages or other content as determined by the public utility or others.

Customer Web Portals.

In an embodiment, there is a customer portal through the customer engagement platform for water-use efficiency interfaces to consumers, public utility agents, and the like in some embodiments. In one embodiment, the customer portal is viewable by customers and includes content (subject to availability of source data from a public utility) such as water-use consumption, water-use comparisons among comparable residences, water score (per billing period), water score and ranking (gallons per capita per day), availability and/or value of a public utility's incentive and/or rebates programs, historical water use comparisons, indoor and/or outdoor water use estimates, suggested ways to save as provided by the systems recommendation module, library of ways to save such as water efficient tips with ranking/sorting capabilities, sign-up/request capability, and the capability to download historical consumption data.

In some embodiments, the customer portal is made available to only those residential customers with active accounts for whom a public utility has provided consumption and residential data. In other embodiments, the system provides opt-in access. For example, customers who access the customer portal by following a link from a generic source, such as a public utility's website, will be required to type-in registration information to access their account details. Once registered, they may view their customer portal immediately. These customers will be emailed their home water report during the next monthly email report distribution cycle. In some embodiments, customers may access the customer portal via a link from the email home water report. Customers who are part of the initial set of email participants also may link to the customer portal by clicking on links within their email report. Such links will contain the registrations codes unique to that specific customer. The registration page of the customer portal will be pre-filled with these codes, to simplify the registration process.

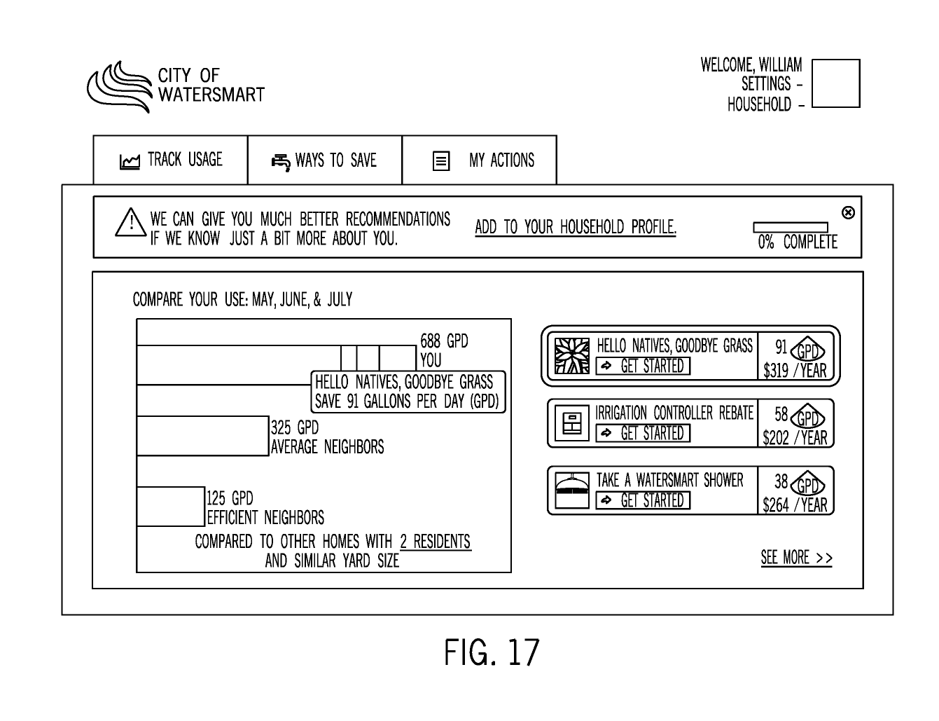

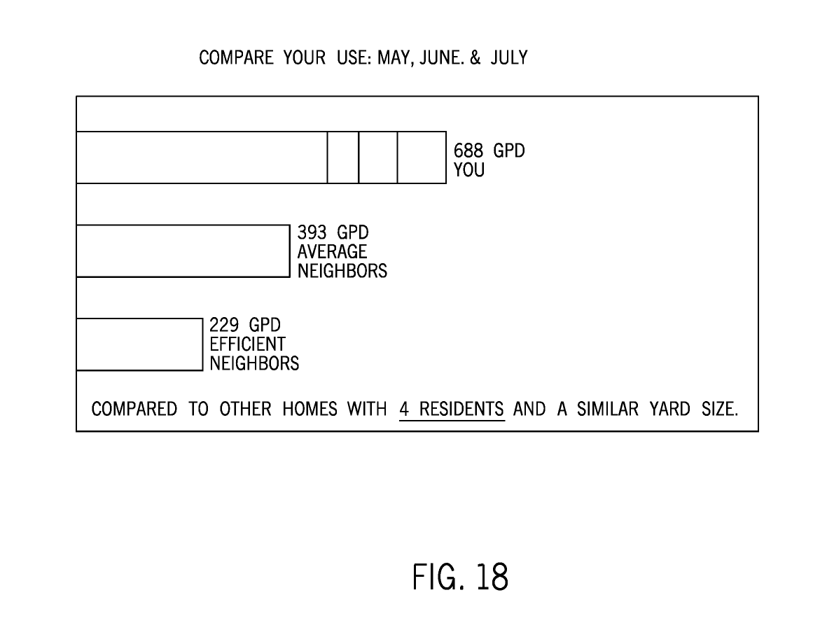

FIGS. 17-20 represent examples of several interfaces generated by the water efficiency customer portal (for households). FIG. 17 illustrates a customer web portal display that couples water usage data with potential action such that it presents a clear visual of the impact consumer action can have. FIG. 18 illustrates another example of the water efficiency customer web portal display in household usage is compared to similar households. FIG. 13 is also an example of such a pie chart depicting water end usage displayed via a customer portal.)

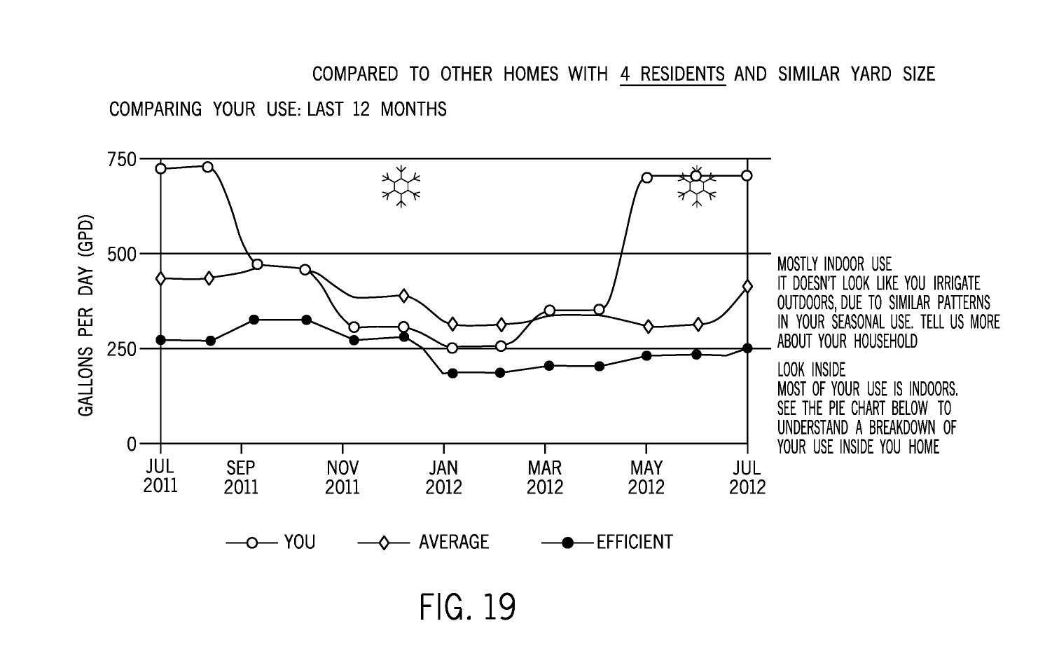

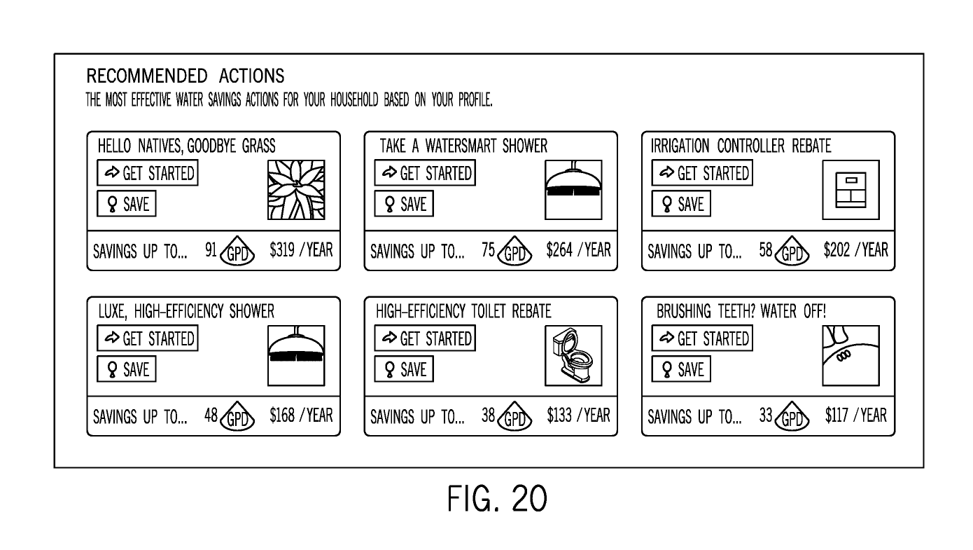

FIGS. 19-20 also illustrate examples of user interfaces generated by the water efficiency customer portal for water-use efficiency in some embodiments. Specifically, FIG. 19 illustrates a customer web portal display that displays a graph comparing seasonal water-usage over the last 12 months compared to the median and efficient households in their cohort bucket. FIG. 20 presents potential savings forecasts for specific water-savings actions.

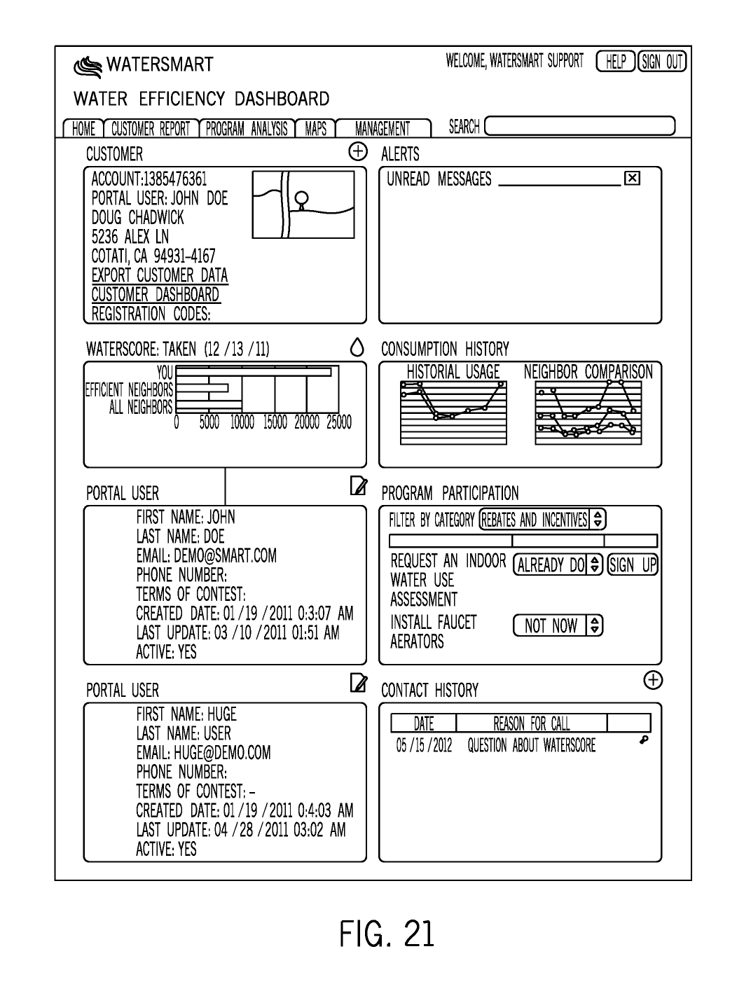

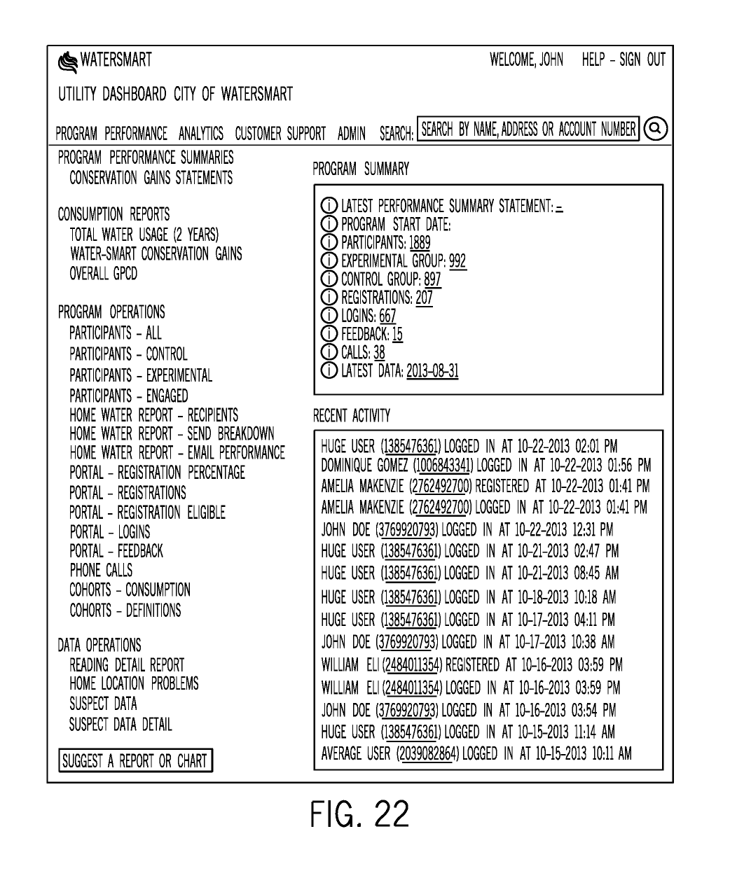

Water Efficiency Dashboard. FIGS. 21 and 22 depict examples of a water efficiency dashboard. In FIG. 21, depicts specific customer account information along with customer web portal user information, consumption history and program participation. FIG. 22 depicts a utility dashboard in which program related information may be accessed in many formats. For example, a utility may access a consumption report showing total water usage over 2 years. Alternatively, a utility user may access a list of all participants in a program.

In general, a water efficiency dashboard may include content such as customer support information, program analytics, and mapped data. Examples of customer support information include, but are not limited to, customer residence profile, customer water score and consumption, median water use for comparable residences, portal user profile, map of customer property, log of customer calls and call history, capability to view every customer's portal, capability to view the unique report sent to each customer, each billing period, customer historical usage and neighbor comparison, and capability to view customer survey responses.

Examples of program analytics include, but are not limited to capability to read the detail reports for all participants, households which may have leaks, median and efficient water use for each group of comparable households/residences, top N (e.g., 100, 200) users for a specific billing period, top N (e.g., 100, 200) users annually, utility program effectiveness report, home water report mailing statistics, and user engagement such as activity related to registration, calls, emails, etc. The occupant (user) engagement activity can be organized by period, water score, message, household demographics, and the like. In regards to home water report mailing statistics, the mailing statistics are available on the water efficiency dashboard and is accessible to the public utility at any time. The system can calculate, on a predetermined time basis (e.g., semi-annual, quarterly), the total number of home water reports that have been sent to households that were not in the initial set of participants.

Examples of mapped data include, but are not limited to, a map of the top N (e.g., 100, 200) occupants/users, a map of program participants, a map of a utility program effectiveness report, and a map of user engagement.

Furthermore, the water efficiency dashboard (form of portal) enables a public utility customer (e.g., utility staff) to view the actual behaviors of participants (households/occupants) by category to determine what is most effective savings or what is the most effective conservation program relating to water usage. For example, a utility staff may realize through the dashboard whether a toilet rebate program or grass removal (or any other savings mechanism) is most effective. As another example, the dashboard may show on a yearly basis water usage before and after grass was removed. The dashboard contributes to a customer's overall strategy on its water usage campaigns and programs on a household-by-household roll out.

Customer Surveys.

Customer surveys are used to gather information about a household and water use. This information is by the customer engagement platform for water use efficiency.

In one embodiment, a customer insight survey is provided by the customer engagement platform for water-use efficiency. The customer insight survey is customizable with specific information from a public utility, such as service area and mailing address. In one embodiment, a program survey may have approximately thirty questions related to occupancy, fixtures, appliances, demographics, water-related attitudes and behaviors. The results of the survey are used to establish baseline attitudes and customer satisfaction, occupancy rates, saturation rates of fixtures and appliances, and customer willingness to implement various water use efficiency behaviors and upgrades. The survey responses can be used by the system and the public utility improve the targeting of water-saving actions at the household level and in aggregate.

In some embodiments, the system may offer a chance to win a cash prize to increase response rates. For example, this lottery offer can be printed on the envelope of the survey or listed in the email as an incentive to complete the survey. After a predetermined time (e.g., one year) after which a water report has been distributed, the system can prepare, print and mail a second survey to the initial set of participants. The second survey can be used to track changes in water awareness, water literacy, attitudes, adoption rates and customer satisfaction as compared to the first survey.

In one embodiment, the system shares some or all of the survey results from both surveys with the public utility and can digitize the completed written surveys. For example, the system can provide a report to the public utility with an analysis of aggregate survey responses. The system can also provide online, password-protected access to the complete set of survey responses, so that the public utility may view all entries, including residents' responses to open-ended questions, to which the public utility may wish to respond.

Incentives.

The customer engagement platform described herein to increase residential water user efficiency may use incentives to encourage a customer to take some action or may some change that may affect or have an impact on his/her water consumption. These incentives are part of gamification strategy to engage the customers and encourage them to take some action with respect to water consumption. These incentives may include prizes both real (cash, bill credit, services) and virtual (points, awards, status, badges). The incentives may also include a lottery as described above, displayed achievements (e.g, “congratulations, you get points for completing your profile,” missions (e.g., if the customer completes 3 water-use behavior changes in the next 3 months), and displayed progress bars (e.g., “you are 80% of the way”) and/or badges (“you are a watersaver!”). In addition, the customer may share his/her status on a social network such as Facebook for commenting, etc. Other incentives include leaderboards (e.g., “here's how you rank compared to the homes on your street.”).

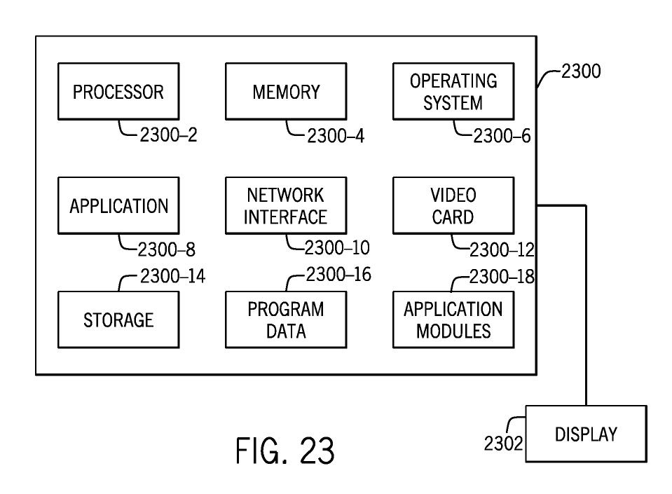

FIG. 23 depicts a block diagram of a general-purpose computer to support the embodiments of the computer-implemented systems and methods disclosed herein. In a particular configuration, the computer may be a computer server as described above with respect to the central server 120 or personal computer. (Central server 120 is configured to enable part or all of the process steps of the application (software) in the embodiments described herein. The computer 2300 typically includes at least one processor 2300-2 and system memory 2302-4 (volatile RAM or non-volatile ROM). System memory 2302-4 may include computer readable media that is accessible to the processor 2300-2. The memory 2302-4 may also include instructions from processor 2300-2, an operating system 2300-6 and one or more application platforms 2300-8 such as Java and a part of a software component or one or more software modules/applications 2300-18. The computer will include one or more communication connections such as a network interface 2300-10 to enable the computer to communication with other computers over a network, storage 2300-14 such as a hard drives for storing data 2300-16 and other software described above, video cards 2300-12 and other conventional components known to those skilled in the art. This computer 2300 typically runs Unix or Microsoft as the operating system and include TCP/IP protocol stack (to communicate) for communication over the Internet as known to those skilled in the art. A display 2302 is optionally used.

It is to be understood that the disclosure teaches examples of the illustrative embodiments and that many variations of the invention can easily be devised by those skilled in the art after reading this disclosure and that the scope of the present invention is to be determined by the claims below (i.e., below the example modules, water savings recommendation library and availability criteria).

### Personalized Home Water Report

### Example Modules

### Layout Modules

Utility Branding Module

Personal Information Module

Address Module

### Current Water Use Modules

Empathetic Gauge Module (happy/sad)

Water Score Module

Social Comparison Module

### Data Insight Modules

Annual Water Consumption Module

Water End-Use Breakdown Module

You vs WaterSaverYou Module

This Year vs Last Year Water Use Module

Seasonal Use Module

Last 12 Months Use Module

Messages Modules (sample subset)

Leak Alert Message Module

Water Score Achievement Message Module

Online Conversion Message Module

Cohort Description Message Module

User Testimonial Message Module

Watering Schedule Message Module

Utility Program/Event Message Module

About Your Report Message Module

Seasonal Irrigation Message Module

Where Water Comes from Message Module

### Recommended Actions Modules

Recommendation Module (see below)

Gallons Per Day Savings Module

Dollars Per Year Savings Module

### Water Savings Recommendation Library

### Celebrate Irrigation Month

### Change Your Sprinklers to Drip Irrigation

Check for moisture before watering
Check Irrigation System—seasonal tune-up
Choose water wise plants

### Control Your Controller

Defrost food in microwave

### Don't Water the Sidewalk

Fill bath ⅓ full
Find and fix an irrigation system leak

### Fix Leaky Showerheads

Fully load dishwasher
Fully load washer

### Gardening Workshop

Give the gift of water savings

### Greywater Reuse

### Great Gardening Resources

### Greywater Workshop

### Install a Hot Water Recirculation Pump

### Install a Rainwater Catchment System

### Install Pool Cover

### Insulate Your Water Heater Tank and Water Pipes

Keep pitcher in refrigerator
Know your home

### Landscaping 101

### Meet Your Meter

Minimize fertilizer

### Mulch

Mulching lawnmower
Only wash what's necessary

### Pressure Regulator Valve

### Raise Lawnmower Blades

Regularly check for leaks
Replace lawn w/ artificial turf
Replace Lawn w/ low-water-use plants
Reuse cold shower water

### Reuse Cooking Water

### Reuse Greywater

### Soil Moisture Sensor System

### Split Irrigation Zones

### Stop a Burst Hose

### Stop a Leaking Toilet

Stop winter irrigation

### Think Before You Flush

Toilet displacement device
Turn off water while brushing teeth
Turn off water while shaving
Turn off water while washing hands
Upgrade HE dishwasher
Upgrade HE washer
Upgrade HET toilet

### Availability Criteria

had_audit

had_indoor_audit

had_lawn_conversion

had_outdoor_audit

had_toilet_retrofit_1980

had_toilet_retrofit_1994

has_ami_data

has_answered_key_profile

has_faucet_aerators

has_irrigation

has_one_year_data

has_pool

has_timed_controller

has_two_years_data

has_uncovered_pool

has_wb_controller

high_use

is_high_suspect_data

is_leak_suspect_data

is_registered

is_ws_good

is_ws_great

is_ws_take_action

likely_replace_lawn

likely_replace_sprinklers

likely_upgrade_dishwasher

likely_upgrade_faucet

likely_upgrade_irrigation_controller

likely_upgrade_shower

likely_upgrade_toilet

likely_upgrade_washer

nonzero_lot

owner_occupied

post_1994_home

seasonal_usage

toilet_retrofit_1980

toilet_retrofit_1994

What is claimed is:

1. A computer-implemented method for providing a customer engagement platform to increase residential water use efficiency, wherein the method is implemented in one or more servers programmed to execute the method, the method comprising:
measuring water usage data periodically, with the one or more servers, of a household;
analyzing the water usage data, with the one or more servers, to determine a water leak at a household;
recording leak data, with the one or more servers, if a water leak is determined; and
displaying the leak data to occupant.

2. The computer-implemented method of claim 1 further comprising enabling, with the one or more servers, occupant to confirm or refute leak.

3. The computer-implemented method of claim 2 further comprising receiving confirmation or refutation of leak, with the one or more servers.

4. The computer-implemented method of claim 1 wherein the data is analyzed to determine a continuous flow leak or a large leak.

5. The computer-implemented method of claim 1 wherein analyzing comprises selecting first data below a leak flow threshold.

6. The computer-implemented method of claim 5 wherein analyzing further comprises recording a leak start and end time if the first data is not maintained below a threshold within a leak time threshold.

7. The computer-implemented method of claim 5 wherein analyzing further comprises calculating leak flow rate.

8. The computer-implemented method of claim 7 wherein analyzing further comprises calculating gallons lost as leak flow rate over time.
